(19) United States
(12) Patent Application Publication
(10) Pub. No.: US 2013/0160361 A1
(43) Pub. Date: Jun. 27, 2013

(54) Container, Soil Blend, and Method of Growing Plants

(71) Applicant: Tropicana Products, Inc., Brandenton, FL (US)

(72) Inventor: James H. Keithly, Brandenton, FL (US)

(73) Assignee: TROPICANA PRODUCTS, INC., Brandenton, FL (US)

(21) Appl. No.: 13/724,689

(22) Filed: Dec. 21, 2012

Related U.S. Application Data
(60) Provisional application No. 61/579,938, filed on Dec. 23, 2011.

(51) Int. Cl. A01G 9/02; C05B 15/00

(52) U.S. Cl. CPC A01G 9/02; C05B 15/00
USPC 47/66.7; 47/65.5; 71/24

(57) ABSTRACT

Containers having air pruning holes are have dimensions configured for germination and/or growth of citrus plants, including citrus rootstock, as well as other plants. One such container may have a width of about 1.0 to 1.25 inches and a depth of about 5.0 to 7.0 inches. Another such container may have a width of about 4.0 to 6.0 inches and a depth of about 12.0 inches to 14.0 inches. Soil blends containing various additives configured for use in germination and/or growth of citrus and other plants may be used in connection with the containers or independently of the containers.

### CROSS-REFERENCE TO RELATED APPLICATION

This application claims priority to and the benefit of U.S. Provisional Application No. 61/579,938, filed Dec. 23, 2011, which application is incorporated by reference herein in its entirety and made part hereof.

### TECHNICAL FIELD

The invention relates generally to containers and soil blends for growing plants and methods of using the same, and in a more specific embodiment, for germinating and/or growing citrus rootstock for grafting and other citrus seedlings.

### BACKGROUND

Plant growers and breeders can realize great benefit from technologies that improve the rate and/or the type of growth of the plants with which they work. Citrus rootstock growers, for example, seek technologies that improve root growth, for example by enhancing root growth rate, improving root density, increasing taproot length, increasing secondary root growth, avoiding fungi and other diseases or parasites, etc. Additionally, interests in achieving improved root growth are often balanced against interests in minimizing growing space so as to permit a larger number of plants to be grown in a particular space, as well as against cost of production. Accordingly, technologies that can achieve improved root growth and/or minimize growing space can be extremely beneficial to the citrus rootstock growth industry, as well as other areas of the citrus industry and other types of plant growing industries. Further, labor costs can constitute up to 80-85% of citrus nursery costs, and thus, decreasing nursery time by increasing growth rate can be extremely cost-effective and advantageous. Some of these advantages and benefits may be achieved by the use of growing containers that have specific structural features or other features that can improve growth. Some of these advantages and benefits may additionally or alternately be achieved by the use of a soil having an improved blend or formulation.

### BRIEF SUMMARY

The present invention related generally to containers and soil media for use in germination and/or growth of citrus or other plants. Aspects of the invention relate to a container that includes a sidewall defining an internal cavity having an outermost peripheral dimension, a top having an opening providing access to the cavity and a bottom, with a depth defined between the top and the bottom, the cavity configured to hold a soil medium and a plant growing in the soil medium, and a plurality of air pruning holes defined within the sidewall and extending through the sidewall, the air pruning holes being dispersed across the sidewall. The outermost peripheral dimension of the sidewall has a width of about 1.0 to 1.25 inches and the depth is about 5.0 to 7.0 inches. At least some of the air pruning holes may be circular. Further, a method may be utilized in connection with such a container, which includes placing a soil medium within the cavity of the container and placing a seed within the soil medium, wherein the seed germinates to produce a plant growing in the soil medium.

According to one aspect, the sidewall is at least partially conical and a width of the cavity decreased from the top toward the bottom, and the container is configuring for holding a seed for germination to create the plant.

According to another aspect, the sidewall has a width-to-depth ratio of approximately 0.18, based on the width of the outermost peripheral dimension.

According to a further aspect, the bottom of the sidewall is open, and a number of the air pruning holes are located around the bottom.

Additional aspects of the invention relate to an assembly that includes a tray and a plurality of containers as described above connected to and supported by the tray, each of the containers holding a soil medium and a plant growing in the soil medium at least partially within the cavity.

Further aspects of the invention relate to a container that includes a sidewall defining an internal cavity having an outermost peripheral dimension, a top having an opening providing access to the cavity and a bottom, with a depth defined between the top and the bottom, the cavity configured to hold a soil medium and a plant growing in the soil medium, and a plurality of air pruning holes defined within the sidewall and extending through the sidewall, the air pruning holes being dispersed across the sidewall. The outermost peripheral dimension of the sidewall has a width of about 4.0 to 6.0 inches and the depth is about 12.0 inches to 14.0 inches. Further, a method may be utilized in connection with such a container, which includes placing a soil medium within the cavity of the container and transplanting a plant to the container, such that a root of the plant is at least partially within the soil medium, and the plant is supported by the soil medium

According to one aspect, the sidewall further includes a plurality of tubular structures extending outwardly from the sidewall, each tubular structure defining one of the air pruning holes therethrough. The sidewall may also include a plurality of inwardly-extending projections extending into the cavity, the projections being located between the tubular structures.

According to another aspect, the sidewall is cylindrical in shape and the bottom of the sidewall is open. In one embodiment, the depth of the sidewall is 14.0 inches and the width of the sidewall is 6.0 inches. Additionally, the sidewall may have a width-to-depth ratio of approximately 0.43, based on the width of the outermost peripheral dimension.

Still further aspects of the invention relate to soil blends or media that can be used in connection with, or independently of, the containers as described above. One such soil medium includes about 40% peatmoss, about 30% Coconut coir, and about 30% Cyprus bark sawdust and one or more of the following additives, with each additive having a range of +/−10% of listed amounts:
5 lb. dolomite limestone per finished yard;
5 lb. gypsum per finished yard;
4 lb. micronutrients per finished yard;
18.5 lb. humic acid per finished yard; and
10 lb. slow-release NPK supplement per finished yard.
   Another such soil medium includes about 30% peatmoss, about 20% Coconut coir, about 20% Cyprus bark chips, and about 20% Cyprus bark sawdust, and about 10% perlite and one or more of the following additives, with each additive having a range of +/−10% of listed amounts:
5 lb. dolomite limestone per finished yard;
5 lb. gypsum per finished yard;
5 lb. coarse grade limestone per finished yard;
4 lb. micronutrients per finished yard;
18.5 lb. humic acid per finished yard; and
20 lb. slow-release NPK supplement per finished yard.

Other aspects of the invention relate to an assembly that includes one of the containers as described above, one of the soil media as described above at least partially filling the cavity, and a plant growing in the soil medium.

Still other features and advantages of the invention will be apparent from the following specification taken in conjunction with the following drawings.

### DESCRIPTION OF THE DRAWINGS

To allow for a more full understanding of the present invention, it will now be described by way of example, with reference to the accompanying drawings in which:

FIG. 1 is a top perspective view of one embodiment of a container according to the present invention, supporting a plant growing in soil;

FIG. 2 is a bottom perspective view of the container of FIG. 1;

FIG. 3 is a top perspective view of a container assembly including a tray supporting a plurality of containers as shown in FIG. 1;

FIG. 4 is a top perspective view of another embodiment of a container according to the present invention;

FIG. 5 is a top perspective view of the container of FIG. 4, supporting a plant growing in soil;

FIG. 6 is a bottom perspective view of the container of FIG. 4;

FIG. 7 is a top perspective view of another embodiment of a container according to the present invention, supporting a plant growing in soil;

FIGS. 8-11 are photographs of a plurality of citrus seedlings grown from germination in different combinations of containers and soil media, according to Example 1 described below;

FIG. 12-15 are photographs of a plurality of citrus seedlings transplanted and grown in different combinations of containers and soil media, according to Example 2 described below;

FIGS. 16-17 are photographs of a plurality of citrus seedlings transplanted and grown in different containers and soil media, according to the Secondary Study portion of Example 2 described below; and

FIGS. 18-19 are photographs of citrus seedlings grown in different containers and soil media, according to Example 3 described below.

### DETAILED DESCRIPTION

Generally, aspects of the invention are usable in connection with the production of citrus plants, such as any of a variety of oranges, grapefruit, lemons, limes, tangerines, pomelos, and other citrus fruits and hybrids of such fruits, however some or all of the aspects described below may be usable in connection with production of other types of plants. For example, aspects of the invention may be usable in connection with production of any type of tree, including any fruit or nut trees, such as (without limitation) apple, cashew, and coconut trees, as well as other types of trees. Aspects of the invention may further be usable in connection with production of various other types of plants, including fruit-bearing, nut-bearing, seed-bearing, flowering, ornamental, legume, and other types of plants. It is understood that some aspects and features may be modified to adapt to the production of such other types of plants. Such production of plants may include germination of seedlings and growth until ready for transplanting or beyond. Some aspects may be beneficial in creating strong and dense root systems in citrus and other plants, which can provide particular advantages for rootstock production.

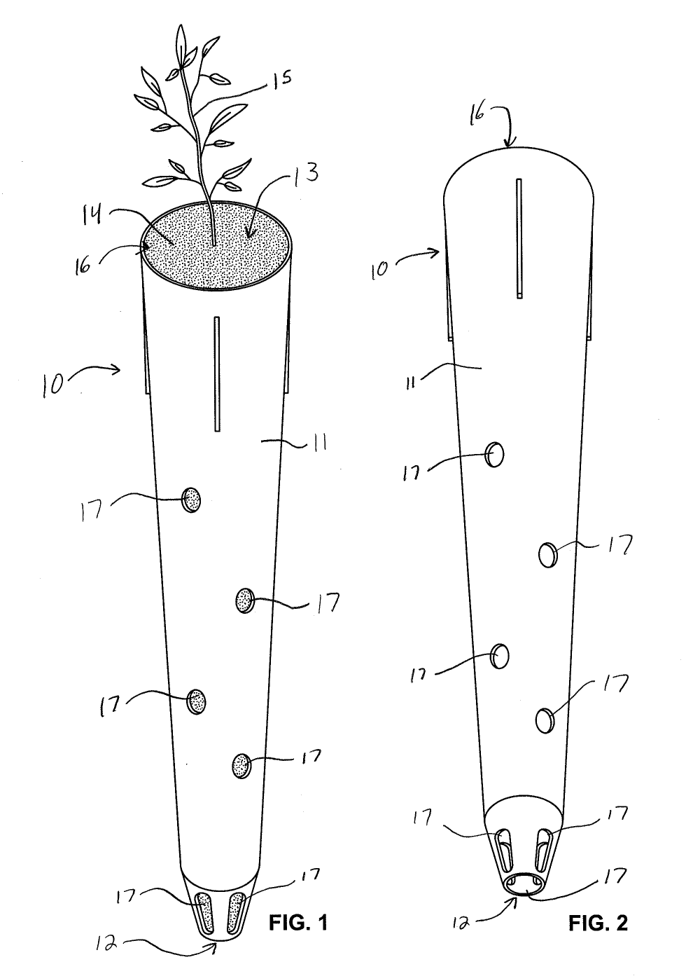

Aspects of the invention relate to a container that is usable for seedling germination and/or growth of citrus plants and other types of plants. In general, the container has a wall or walls defining a growth chamber, where at least a portion of the wall(s) contains air pruning holes. One embodiment of such a container 10 is illustrated in FIGS. 1-2. In this embodiment, the container 10 includes a sidewall 11 and a bottom 12 that define a cavity 13 configured for holding and supporting soil 14 and a plant 15 growing in the soil 14, and an open top 16 to permit access to the cavity and growth space for the plant 15. As shown in FIG. 1, the top 16 is completely open, but could be at least partially covered in another embodiment. In the embodiment shown, the sidewall 11 is conical in shape, and the bottom 12 is formed by the point of the conical sidewall 11. Additionally, in the embodiment shown, the container 10 has a top 16 with a width (e.g. diameter) that is 1.25 inches and has a total depth from the top 16 to the bottom 12 that is 7.0 inches. Viewed another way, the width to depth ratio of the container 10 (using the outermost peripheral dimension of the cavity 13 as the width) is approximately 0.18. In another embodiment, the container may have a top width of 1.0″-1.25″ and a height of 5.0″ to 7.0″, and may have a width to depth ratio that is approximately 0.14 to 0.25. In other embodiments, the sidewall may have a different shape, such as a circular cylindrical, square cylindrical, or other cylindrical sidewall, a pyramidal sidewall, or a partially conic or partially pyramidal sidewall having a flat bottom, and/or may have a different size. For example, in other embodiments, the width, depth, and/or width to depth ratio of the container 10 may vary by 5%, 10%, or 20%.

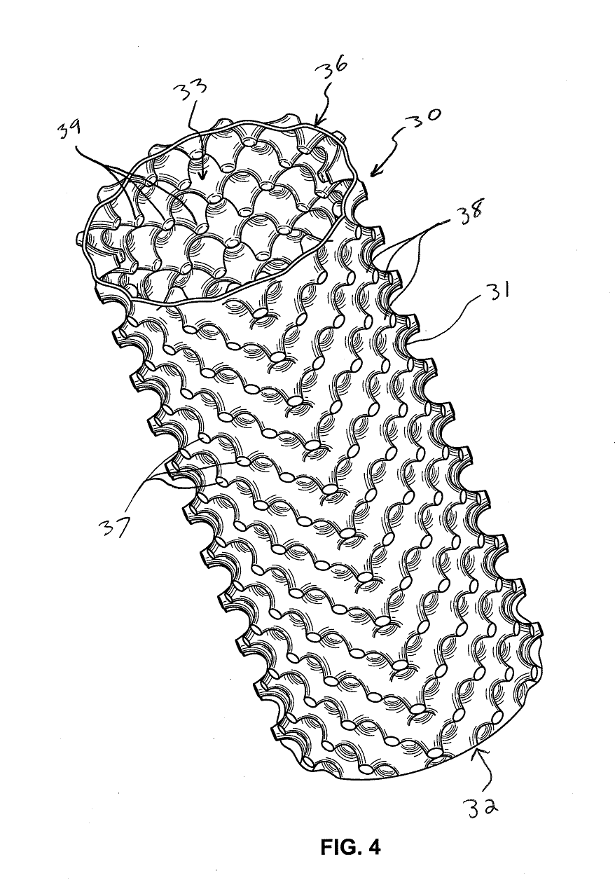

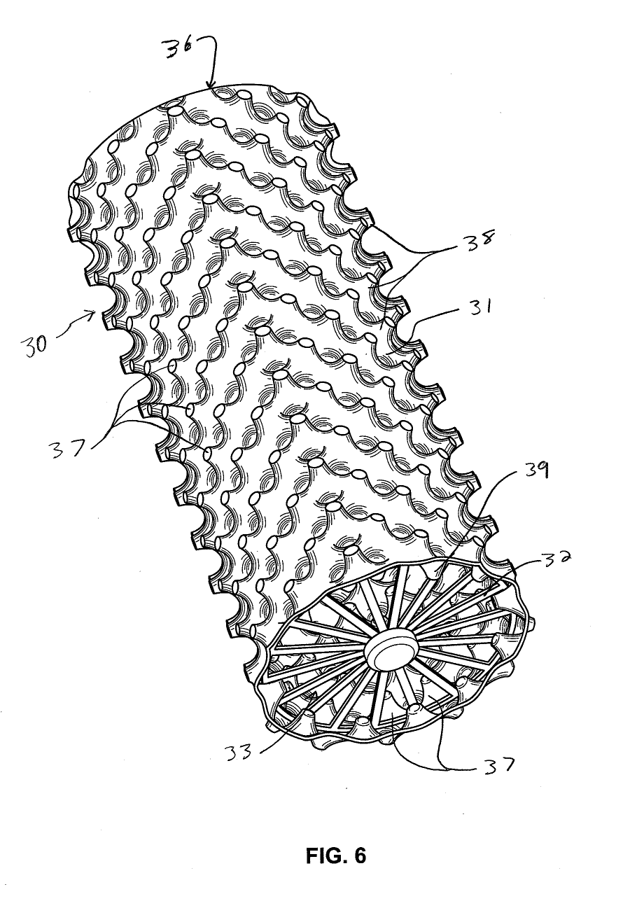

As shown in FIGS. 1-2, the container 10 has air pruning holes 17 located in the sidewall 11 and in the bottom 12. In this embodiment, the holes 17 are distributed or dispersed fairly evenly across the sidewall 11, and may be distributed in an identifiable pattern. In this embodiment, the holes 17 have constant diameters of ⅜ inch or approximately ⅜ inch, but may have other sizes in other embodiments. Additionally, holes 17 may be located around the bottom 12 of the container 10, along with a single hole 17 at the lowermost point of the bottom 12 (i.e. the tip of the container 10). In another embodiment, where the container 10 has a flat bottom wall (not shown), the bottom wall may also have multiple air pruning holes 17. In a further embodiment, only portions of the sidewall 11 may have holes 17 therein. The holes 17 illustrated in FIGS. 1-2 are circular apertures extending straight through the sidewall 11, however in another embodiment, the holes 17 may be in the form of elongated passages formed by tubular sidewall structures, similar to the container 30 shown in FIGS. 4-6.

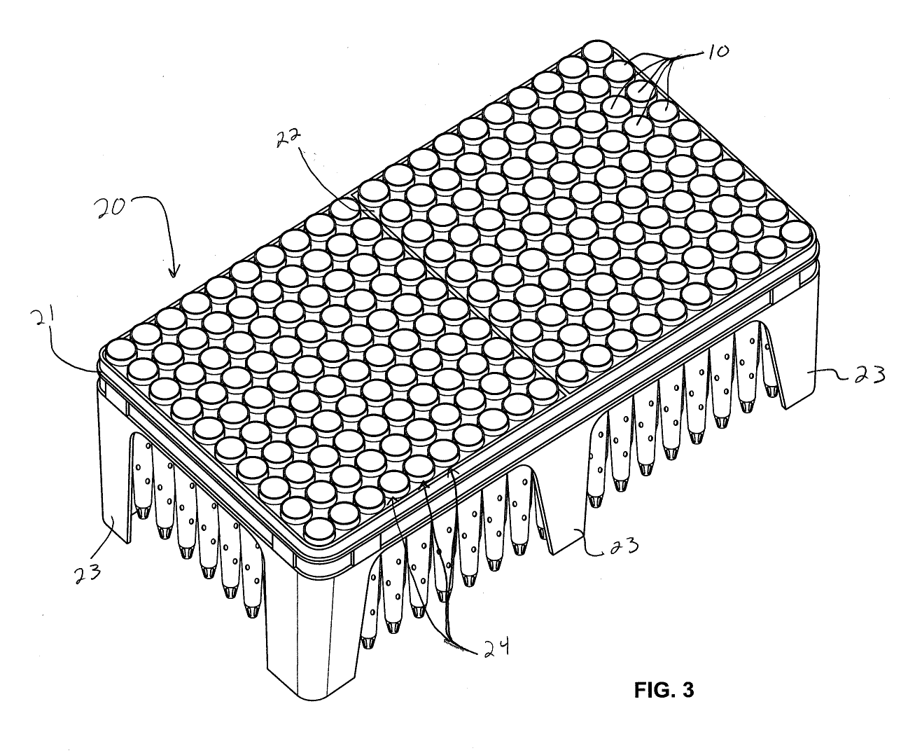

The container 10 may also be formed as part of a container assembly 20 that includes a plurality of containers 10 connected to a tray 21, as shown in FIG. 3. The tray 21 generally has a flat and/or planar support surface 22 that supports the containers 10 to enable a number of containers 10 to be handled and moved together, and support legs 23 connected to the support surface 22. In the embodiment shown, the tray 21 has a plurality of apertures 24 that receive the containers 10 and support the containers 10, such as by interference fit and/or complementary engaging structures (e.g. lips, flanges, grooves, etc.). Accordingly, the containers 10 are removably connected to the tray 21. In another embodiment, the tray 21 and the containers 10 may be permanently connected, such as being formed of a single and/or integral piece, or being connected by adhesive or other permanent bonding technique. In a further embodiment, the containers 10 may be removably connected to the tray 21, by a fastener or a snapping or interlocking connection. Additionally, in the embodiment shown, the tray 21 supports a plurality of identical containers 10 arranged in an evenly-spaced grid structure. In another embodiment, the tray 21 may support the containers in a staggered pattern with rows having different numbers of cells. The arrangement, size, and other features of the assembly 20 may be changed in other embodiments.

The container 10 and the assembly 20 may be used in germinating plant seedlings, such as citrus seedlings, and growing the seedlings until they are suitable for transplantation to a larger container, such as the container 30 shown in FIGS. 4-6. Methods of use for the container 10 and the assembly 20, including examples of such use, are described below.

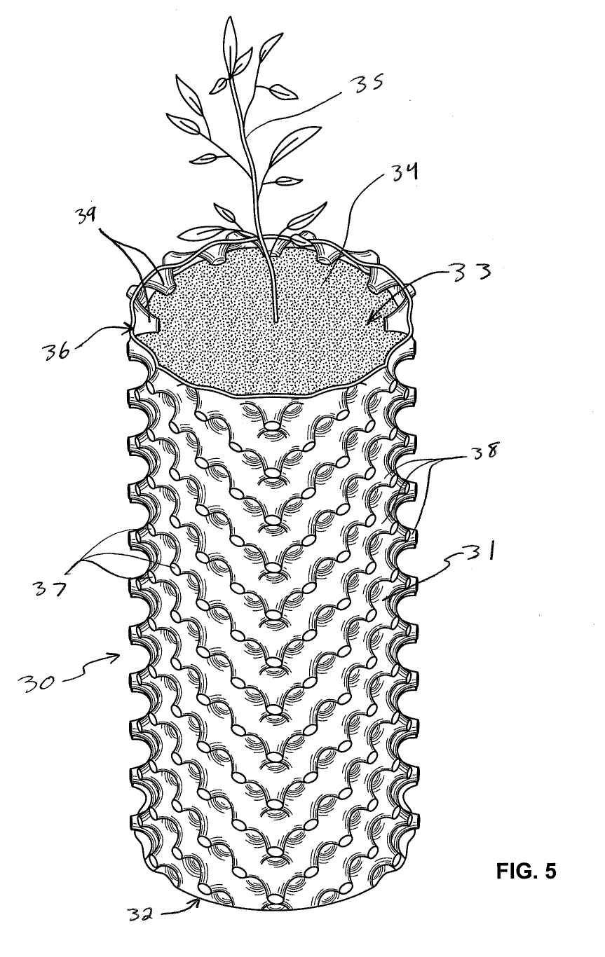

Additional aspects of the invention relate to a container that is usable for supporting growing citrus plants and other types of plants. In general, the container has a wall or walls defining a growth chamber, where at least a portion of the wall(s) contains air pruning holes. One embodiment of such a container 30 is illustrated in FIGS. 4-6. In this embodiment, the container 30 includes a sidewall 31 and a bottom wall 32 that define a cavity 33 configured for holding and supporting soil 34 and a plant 35 growing in the soil 34, and an open top 36 to permit access to the cavity and growth space for the plant 35. As shown in FIGS. 4-5, the top 36 is completely open, but could be at least partially covered in another embodiment. In the embodiment shown, the sidewall 31 is cylindrical in shape, with a flat bottom wall 32. Additionally, in the embodiment shown, the container 30 has a top 36 with a width (e.g. diameter) that is 4.0 inches, and has a total depth from the top 36 to the bottom 32 that is 14.0 inches. In this embodiment, the container 30 has a uniform cross section, and accordingly, the top 36 of the container has a width equal to the widest or outermost peripheral dimension (in this case, diameter) of the container 30. Thus, the width to depth ratio of the container 30 is approximately 0.28, using the outermost peripheral dimension of the cavity 33 as the width, and the volume is approximately 176 cubic inches. In another embodiment (not shown), the width of the top 36 of the container 30 is 6.0 inches (equal to the outermost peripheral dimension of the container 30) and the depth is 14.0 inches, with a width to depth ratio of 0.43 and an approximate volume of 396 cubic inches, which will hold at least one gallon of material. In a further embodiment, the container 30 has a top 36 with a width of 4.0″ to 6.0″ and a depth of 12.0″ to 14.0″, which may result in a width to depth ratio of 0.28 to 0.50, and may have a volume that is approximately one gallon. In still further embodiments, the sidewall may have a different shape, such as a square cylindrical or other cylindrical sidewall, a conic or pyramidal sidewall, or a partially conic or partially pyramidal sidewall having a flat bottom, and/or may have a different size. For example, in other embodiments, the width, depth, and/or width to depth ratio of the container 30 may vary by 5%, 10%, or 20%.

As shown in FIGS. 4-6, the container 30 has air pruning holes 37 located in the sidewall 31. In this embodiment, the holes 37 are distributed fairly evenly across the sidewall 31, and may be distributed in an identifiable pattern. The holes 37 are formed by a plurality of tubular structures 38 that protrude outwardly from the sidewalls 31 of the container 30. In this embodiment, the holes 37 have diameters of 5 mm or approximately 5 mm at the outermost ends of the tubular structures 38, with the width tapering to become more narrow from the cavity 33 outward. The sidewall 31 also has inward projections 39 that project inwardly into the cavity 33 and are located in spaces between the holes 37. The shapes of the tubular structures 38, the holes 37, and the projections 39 encourage roots of the plant 35 to grow through the holes 37 toward the exterior of the container 30. Holes 37 are also located in the bottom wall 32 of the container 30, in the form of slots/apertures. In another embodiment, where the container 30 has a conical shape with a pointed bottom, air pruning holes 37 may be located around the bottom. In a further embodiment, only portions of the sidewall 31 may have holes 37 therein. In another embodiment, the holes 37 may all be in the form of apertures extending straight through the sidewall 31, similar to the container 10 shown in FIGS. 1-2.

In one embodiment, the container 30 may be used in growing plant seedlings, such as citrus seedlings, after they have been transplanted from a smaller container such as the container 10 described above and shown in FIGS. 1-2. The container 30 may be used until the seedling has grown to a size suitable for transplantation to a larger container or for grafting for use as rootstock. In other embodiments, the container 30 may be used for a different purpose. Methods of use for the container 30, including examples of such use, are described below.

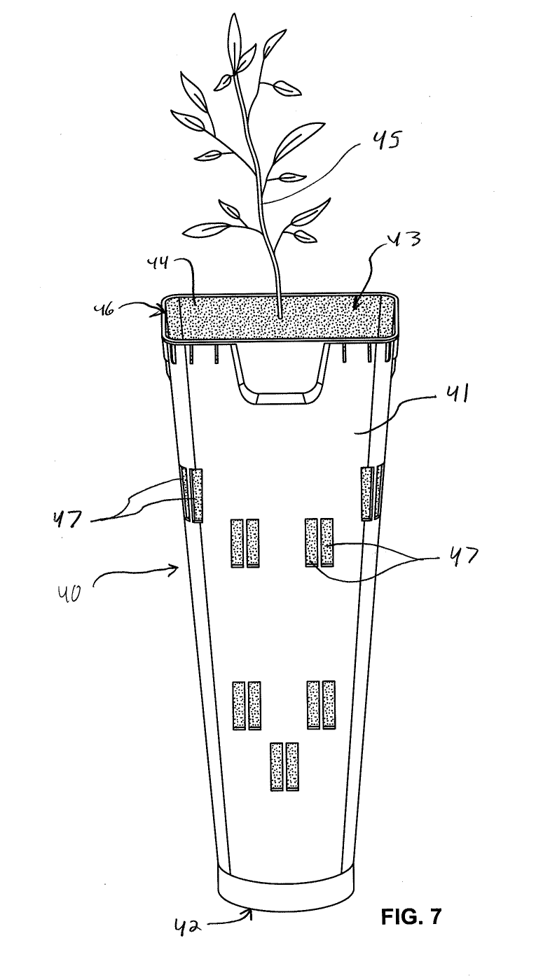

FIG. 7 illustrates an alternate embodiment of a container 40 that is usable for supporting growing citrus plants and other types of plants. Similar to the container 30 described above and shown in FIGS. 4-6, the container 40 includes a sidewall 41 and a bottom wall 42 that define a cavity 43 configured for holding and supporting soil 44 and a plant 45 growing in the soil 44, and an open top 46 to permit access to the cavity and growth space for the plant 45. In this embodiment, the container 40 is substantially square in cross-section, and the sidewall has a tapering cylindrical shape that tapers inward from the top 46 to the flat bottom wall 42, which may also be referred to as a partially-pyramidal shape. Additionally, in the embodiment shown, the top 46 of the container 40 has a width (edge length) that is 4.0 inches, and has a total depth from the top 46 to the bottom 42 that is 14.0 inches, with an approximate volume of one gallon. The container 40 includes air pruning holes 47 in the sidewall 41, in the form of elongated slots that are cut into the sidewall 41. The bottom wall 42 may also contain one or more air pruning holes (not shown). In other embodiments, the holes 47 may take a different form, including other forms described herein. It is understood that the container 40 can be used for similar purposes and in similar methods of use as the container 30 of FIGS. 4-6, and that any features or variations of the container 30 (or other embodiments thereof) described above may be included in the container 40 shown in FIG. 7.

Further aspects of the invention relate to blends or formulations of soil that can be used in connection with growing citrus plants or other types of plants, including citrus seedlings in one example. As used herein, the term “soil” refers generally to any material that is designed for, or otherwise capable of use in, providing a medium for growing plants, such as by supporting plant roots and providing the roots with access to moisture and nutrients. It is understood that different soil blends may be used for different stages of the growth process, for example, a first soil blend may be used for the germination and early seedling growth, and a second soil blend may be used for further growth after transplanting.

In one embodiment, a soil blend A may include approximately: 40% peatmoss (e.g. Canadian peatmoss), 30% Coconut coir, and 30% Cyprus bark sawdust. Additives to the soil may include one or more of the following:
5 lb. dolomite limestone per finished yard
5 lb. gypsum per finished yard
4 lb. micronutrients per finished yard
18.5 lb. humic acid (e.g. HuMaxx) per finished yard
10 lb. nitrogen-phosphorus-potassium (“NPK”) supplement (e.g. 15-6-12 Polyon 270 day NPK+) per finished yard.

In one embodiment, the soil blend A includes all of the above additives in the approximate amounts listed. Additionally, the soil blend A may include variations in the soil composition and/or the additive amounts of up to 5% of the nominal values in one embodiment, up to 10% in another embodiment, and up to 20% in a further embodiment. The soil blend A, including the different embodiments and variations described above, may be advantageous for use as a medium for seed germination and early growth, as well as for long term growth (e.g. after transplanting to a larger pot). The soil blend A may also be advantageous for other purposes as well.

In another embodiment, a soil blend B may include approximately: 30% peatmoss (e.g. Canadian peatmoss), 20% Coconut coir, 20% Cyprus bark chips, and 20% Cyprus bark sawdust, and 10% perlite. Additives to the soil may include one or more of the following:
5 lb. dolomite limestone per finished yard
5 lb. gypsum per finished yard
5 lb. coarse grade limestone (e.g. Ohio dolomite limestone) per finished yard
4 lb. micronutrients per finished yard
18.5 lb. humic acid (e.g. HuMaxx) per finished yard
20 lb. NPK supplement (e.g. 15-6-12 Polyon 450 day NPK+) per finished yard.

In one embodiment, the soil blend B includes all of the above additives in the approximate amounts listed. Additionally, the soil blend B may include variations in the soil composition and/or the additive amounts of up to 5% of the nominal values in one embodiment, up to 10% in another embodiment, and up to 20% in a further embodiment. The soil blend B, including the different embodiments and variations described above, may be advantageous for use as a medium for long-term growth (e.g., after transplantation), and may also be advantageous for germination and early growth or other purposes as well.

The peatmoss component of the soil blends provides an effective soil base for root growth, and can provide a cross-linking matrix for supporting the root system.

The coconut coir component of the soil blends can also provide a cross-linking matrix for supporting the root system. Additionally, the coconut coir can absorb a significant amount of water and resist breakdown and compaction. Further, the texture of the coconut coir can aid in creating crumbly, springy soil that does not significantly impede downward taproot growth. In one embodiment, the coconut coir used in the soil blends A and/or B has low sodium content and has been washed prior to use. These beneficial effects of using the coconut coir were particularly unexpected and offer significant improvements in taproot length and overall root growth.

The Cypress sawdust and/or chips component of the soil blends can provide resistance to rotting, decomposition, and breakdown, as compared to other types of wood sawdust and/or chips (such as pine). This, in turn, can also help prevent fungal contamination of the soil that may result from rotting, decomposition, and breakdown.

The perlite component of the soil blends assists in reducing packing of the soil, facilitating root growth.

The micronutrient component of the soil blends adds important nutrients to assist in promoting root growth of the plant.

The limestone component of the soil blends (e.g. dolomite and Ohio dolomite) is used to reduce acidity in the soil and adjust its pH. The amount of limestone utilized in the soil blends may vary depend on the acidity of the soil blend, and in one embodiment, the soil acidity may be assayed prior to determining the amount of limestone that is added to the soil blend. The amount of limestone added may vary by up to 20% or more, depending on the acidity. In one embodiment, the limestone is added in sufficient quantities to adjust the pH of the soil blend to approximately 6.5. The gypsum component of the soil blends can likewise be used for pH adjustment.

The humic acid component of the soil blends assists in preventing fungal and microbial growth in the root system. Humic acid can also enhance root growth, and can assist in achieving clean, white root growth. Further, the limestone and the humic acid were found to act synergistically to facilitate uptake of nutrients by the plant roots. This synergistic effect was unexpected and is thought to significantly enhance plant growth.

The NPK supplement component of the soil blends provides essential nitrogen, phosphorous, and potassium to the roots. In one embodiment, the NPK supplement utilized is a slow-release NPK supplement, such as 15-6-12 Polyon 450 day NPK+ or 15-6-12 Polyon 270 day NPK+ supplements. Additionally, in one embodiment, the NPK supplement is mixed into the soil blends A and B, rather than application to the surface of the soil, which permits the NPK supplement to contact the root tips and enhances root growth. The amount of NPK supplement utilized in the soil blends may vary depend on the composition of the soil blend, and in one embodiment, the soil composition may be assayed prior to determining the amount of NPK supplement that is added to the soil blend. The amount of NPK supplement added may vary by up to 20% or more, depending on the soil composition.

Aspects of the present invention also relate to methods of germinating and growing plants using containers and assemblies such as the containers 10, 30, 40 and the container assembly 20 described above and shown in FIGS. 1-7 and/or using soil blends such as the soil blends A and B described above. In one embodiment, a method of germinating and growing citrus seedlings or other plant seedlings uses a container 10 as shown in FIGS. 1-2, and includes planting a seed or seedling 15 in the container 10 along with soil 14 that is contained in the cavity 13 of the container 10. Seeds may be planted no more than 0.25″ under the surface in one embodiment. The soil 14 may be any effective soil, including soil blends A and/or B described above. In one embodiment, the soil blend A is particularly advantageous for use in germinating and growing citrus seedlings using a container 10 as shown in FIGS. 1-2 or similar containers. A container assembly 20 as shown in FIG. 3 may be utilized for planting a plurality of seeds or seedlings, as described above. Seedlings may typically be grown in pots of similar sizes to the container 10 of FIGS. 1-2 for approximately 14 weeks before transplanting to another pot.

In another embodiment, a method of growing citrus seedlings or other plant seedlings uses a container 30 as shown in FIGS. 4-6 or a container 40 as shown in FIG. 7. In this embodiment, the method includes planting a seedling 35, 45 in the container 30, 40 along with soil 34 that is contained in the cavity 33, 43 of the container 30, 40. The seedling 35, 45 may be transplanted from another container, such as the container 10 of FIGS. 1-2. The soil 34 may be any effective soil, including soil blends A or B described above. In one embodiment, both soil blends A and B are advantageous for use in growing citrus seedlings over a long-term period using a container 30, 40 as shown in FIGS. 4-7 or similar containers.

The containers 10, 30, 40 of FIGS. 1-7 and the soil blends A and B described above can enhance root growth and quality, resist fungal and microbial infection, and increase root and plant growth rate. For example, seedlings may typically be grown in pots that are comparable in size to the containers 30, 40 of FIGS. 4-7 for around 90-120 days, however use of the containers 30, 40 along with the soil blends A or B may reduce this time considerably, such as to around 75-80 days. It is contemplated that the use of a combination of the container 10, the container 30 or 40, and the soil blends A and/or B as described above can reduce total growing time until grafting by up to several months, e.g., from 24 months to 18 months. It is also contemplated that these combinations can accelerate fruit bearing productivity in trees 2-5 years after planting. Plants grown using these containers 10, 30, 40 and soil blends A and/or B may produce increased total root growth and mass, including increased secondary root growth. Plants grown using these containers 10, 30, 40 and soil blends A and/or B may also produce greater taproot growth, including larger diameter and greater downward growth, which in turn results in an even larger number of secondary roots and greater root mass.

It is understood that the soil blends A and B may be used for germinating and/or growing citrus seedlings or other plants independently of the containers described herein. These soil blends produce improved root growth independently of the containers 10, 30, 40 of FIGS. 1-7 as illustrated in the Examples below. Likewise, the containers 10, 30, 40 of FIGS. 1-7 can produce improved root growth independently of the soil blends A and B, as also illustrated in the Examples below.

### Example 1

### Germination and Early Growth

Plant material and Seed Germination:

Rootstock seeds of Swingle citrummelo and USDA897 hybrid citranges were sourced from Phillip Rucks Citrus Nursery, Frostproof, Fla., and represent commercial seed inventories. Seeds were planted in standard rootstock production greenhouses on April 29 in a variety of seed germination containers and soil mixtures, as described below. Greenhouse temperatures during seed germination ranged from 85-110° F. day and 75-85° F. night temperatures, which are acceptable for citrus seed germination. Relative humidity (%) during seed germination ranged from 65-85%, which is normal for spring seed germination in enclosed greenhouse structures. Among all treatments, both Swingle and USDA897 rootstock seeds, showed approximately 93% germination, which is typical for the seed lots. The official date of seed germination was recorded as May 15, 2011.

Rootstock Seed Germination Trays and Potting Media:

Seed germination trays utilized include:
Group I: Standard tray having cells that are 1.25″×5″ with a standard solid wall construction and a single hole base, manufactured by Stuewe & Sons, Tangent, Oreg.;
Group II: “Groove Tube” tray having cells that are 2.25″×5.5″, with a solid side wall with root training grooves and an open bottom, manufactured by Stuewe & Sons;
Group III: “Ray Leach Cone-tainer” tray having cells that are 1.25″×7″, with a solid side wall and air pruning holes at the base, manufactured by Stuewe & Sons; and
Group IV: An assembly 20 with containers 10 described above and shown in FIGS. 1-3.

The trays described above were used in connection with different soil media. Group I used a standard citrus nursery soil mixture containing 78% Canadian peatmoss, 12% composted pinebark, and 10% perlite. Groups II-IV used a soil blend corresponding to soil blend A described above:
40% Canadian peatmoss;
30% Coconut coir;
30% Cypress bark sawdust;
5 lb. dolomite limestone per finished yard;
5 lb. gypsum per finished yard;
4 lb. micronutrients per finished yard;
18.5 lb. HuMaxx humic acid per finished yard; and
10 lb. 15-6-12 Polyon 270 day NPK+ per finished yard.

In each treatment group, 200 seeds were planted to produce at least 175 seedlings for later upsizing to larger containers.

Rootstock Seedling Culture:

All rootstocks were grown using standard greenhouse growing conditions that include the following:
1) day temperatures ranged from 90° to 105° F.;
2) night temperatures ranged from 75° to 90° F.;
3) plants were grown under ambient photoperiod without accessory illumination to adjust day-length; and
4) plants received 1600 to 1800 micro-Einstein m⁻² sec⁻¹ photosynthetic photon flux density (PPFD) at bench height.
   Seedlings received both overhead and manual irrigation as needed in order to maintain adequate soil moisture at all times during plant growth. Every third day, the overhead irrigation contained 100 ppm NPK plus micronutrients (GraCo Soluble Fertilizer Co., Cairo, Ga.). As needed, seedlings received treatments of commercial Imidocloprid insecticide and Ridomil fungicide to control insect pests and soil fungi, respectively.

Seedling Harvest and Biomass Analysis:

Within each seed germination treatment group, Swingle and USDA897 seedlings were randomly chosen (N=25) for biomass and plant growth analysis on Aug. 4, 2011, or 97 days after planting and 81 days after germination. Seedlings were cut into root and shoot samples at the soil line. Shoot diameters were determined at 2 inches above soil level. Shoot height was also determined for each seedling. Soil medium was manually removed from each root sample. For dry weight analysis, root and shoot samples (N=25) were randomly divided into groups of five seedlings, replicated five times. Samples were dried at 50° C. overnight to constant dry weight prior to biomass determinations.

Data Analysis:

All plant biomass and plant growth data were subjected to Analysis of Variance (ANOVA). Separations among treatment means were determined according to Duncan Multiple Range Test at the 90% level of confidence. Mean values followed by the same letter are not statistically significant. Table I below illustrates the results of this analysis:

TABLE I

| | | | | |
|---|---|---|---|---|
| | Root Dry | Shoot Dry | | |
| Group ID | Wt (g) | Wt (g) | Stem Ht (cm) | Stem Dia (mm) |

USDA 897 Hybrid citrange (mean values, N = 25)

| | | | | |
|---|---|---|---|---|
| Group I | 0.20 a | 0.58 a | 15.6 a | 1.66 a |
| Group II | 0.41 b | 0.92 b | 21.3 b | 1.68 a |
| Group III | 0.38 b | 0.78 ab | 20.0 b | 1.87 b |
| Group IV | 0.56 c | 0.97 b | 21.5 b | 1.92 b |

Swingle citrummelo hybrid citrange (mean values, N = 25)

| | | | | |
|---|---|---|---|---|
| Group I | 0.44 a | 1.18 a | 22.1 ab | 2.40 a |
| Group II | 0.55 ab | 1.16 a | 18.7 a | 2.67 ab |
| Group III | 0.62 ab | 1.24 ab | 23.4 b | 2.77 ab |
| Group IV | 0.77 b | 1.42 b | 23.9 b | 2.98 b |

Results:

Combination of the soil blend A and air pruning pots (Group IV) significantly increased seedling growth of both Swingle and USDA897 rootstocks. The strongest seedling growth was observed using the container 10 and assembly 20 in FIGS. 1-3 in combination with the soil blend A. All of the growth indices were significantly increased compared to the growth of the standard control seedlings. Importantly, the air pruning vents 17 in the sides of the containers 10 resulted in significantly improved root growth in Group IV when compared to root growth in Groups I-III. Seedlings grown in Groups II and III cells also showed improved growth compared to the Group I cells, however, plant growth in the Groups II and III cells were statistically similar overall. This indicates that both the structure of the container 10 and the formulation of soil blend A were both significant in producing stronger root growth, including increased stem diameter, longer taproot length, and greater root biomass in both Swingle and USDA897 rootstocks during the first 10 weeks of plant growth. The improvement in root mass was particularly large. Shoot weight was also larger in Group IV than in the other Groups (I-III).

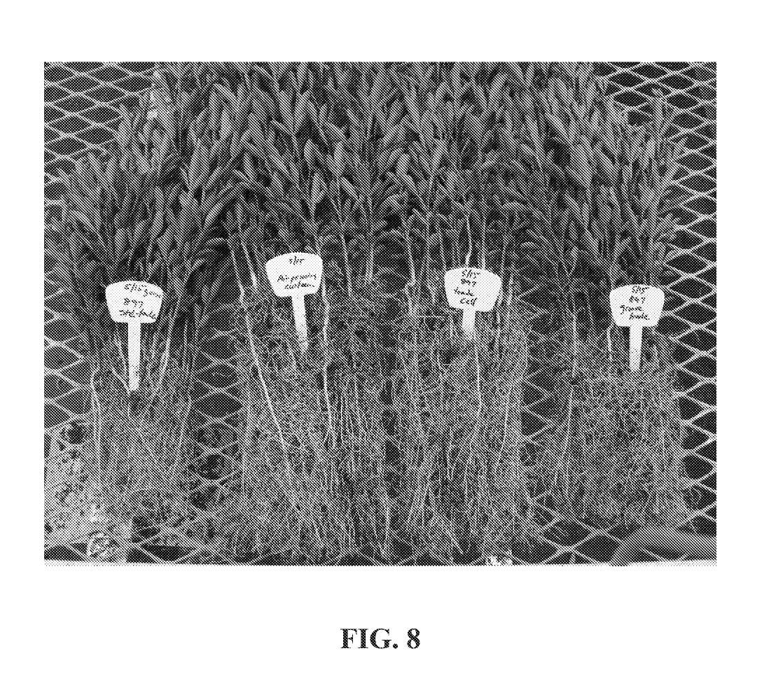

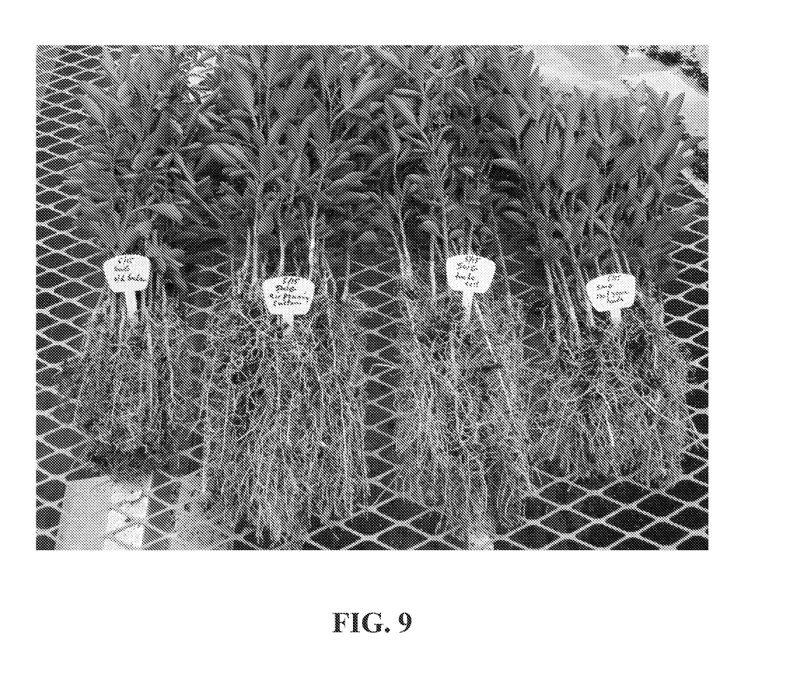

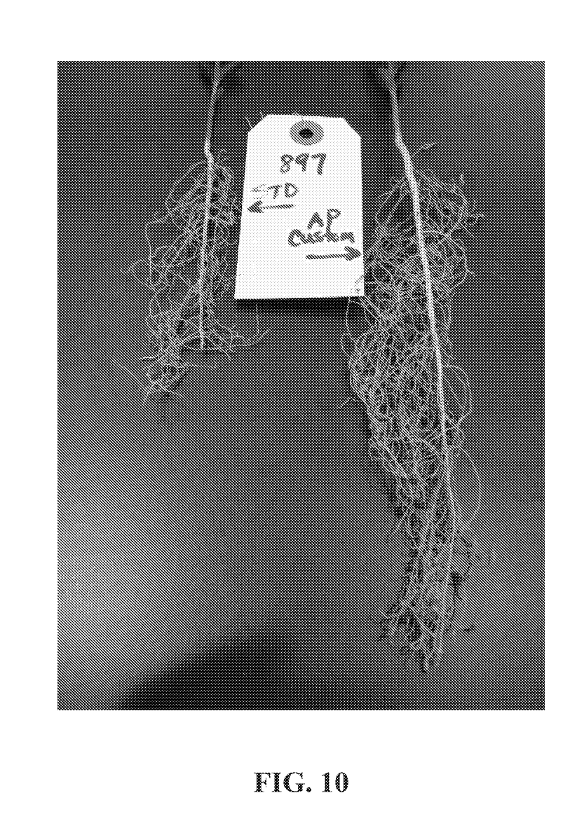

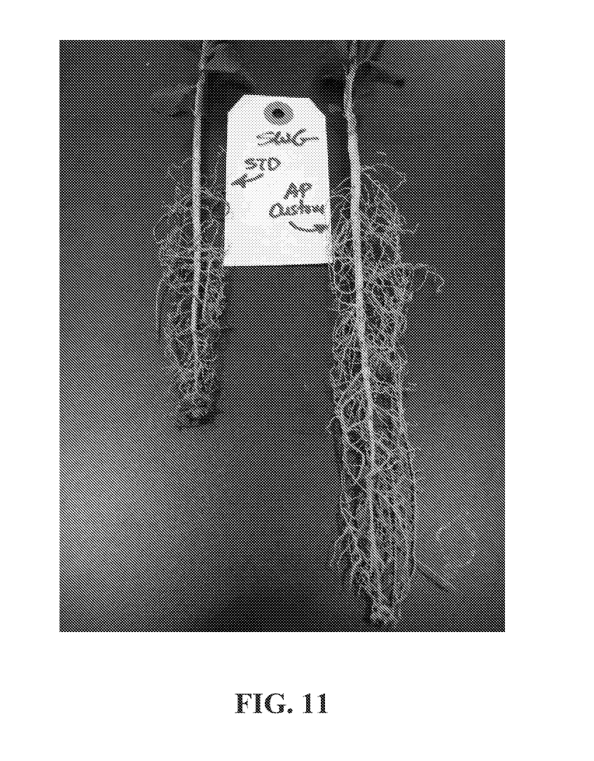

FIGS. 8-11 illustrate seedlings from the study. FIG. 8 depicts the USDA897 seedlings, showing from left to right: Group I, Group IV, Group III, and Group II. FIG. 9 depicts the Swingle seedlings, showing from left to right: Group I, Group IV, Group III, and Group II. FIG. 10 depicts USDA897 seedlings, with a Group I seedling on the left and a Group IV seedling on the right. FIG. 11 depicts Swingle seedlings, with a Group I seedling on the left and a Group IV seedling on the right. These figures illustrate the significantly improved root growth, including taproot length, total root biomass, stem diameter, etc., that can be achieved using a container 10 as shown in FIGS. 1-2 and the soil blend A for germination and early growth of citrus seedlings.

Based on this study, it is evident that seedlings germinated and grown using a container 10 as shown in FIGS. 1-2 or the soil blend A can achieve improved root growth relative to other containers, soil blends, and combinations thereof, and that the combined container 10 and soil blend A can achieve even more improved root growth.

### Example 2

### Long-Term Growth

Plant Material:

Rootstock seedlings of Kuharske hybrid citrange were grown on the premises of Rucks Citrus Nursery, Frostproof, Fla. Seedlings were grown in standard 1.25″×5″ seed germination cells using a standard peat/bark/perlite seed germination medium. The Kuharske seedlings were grown under greenhouse cover using standard greenhouse growing conditions for seedlings, as described above. Seedlings were transplanted to the test pot/soil matrix at approximately 14 weeks after seed germination. On date of transplanting, May 20, 2011, stem diameters at 4 inches above soil level ranged from 1.8 mm to 3.9 mm.

Pots and Growing Media:

The seedlings were transplanted to a matrix of different pots and soil media. The pots included:
Standard Pot: Round, 1.0 gallon pot, 6″ diameter, 9.5″ height, with a solid wall construction with root training grooves, single hole drainage base, manufactured by Stuewe & Sons; and
Air Pruning Pot: The container 30 described above and shown in FIGS. 4-6, with a 4″ diameter and a 14″ height and a 1.0 gallon volume.

These pots were used to form four treatment groups. Each treatment group contained 25 replicates. Each seedling was considered to be an experimental unit. Groups I and II utilized the Standard Pot, and Groups III and IV utilized the Air Pruning Pot. Groups I and III utilized a standard citrus nursery soil mixture, containing 70% Canadian peatmoss, 20% composted pinebark, and 10% perlite. Groups II and IV used a soil blend corresponding to soil blend A described above:
40% Canadian peatmoss;
30% Coconut coir;
30% Cypress bark sawdust;
5 lb. dolomite limestone per finished yard;
5 lb. gypsum per finished yard;
4 lb. micronutrients per finished yard;
18.5 lb. HuMaxx humic acid per finished yard; and
10 lb. 15-6-12 Polyon 270 day NPK+ per finished yard.

Rootstock Seedling Culture:

After transplanting to one gallon containers, the Kuharske rootstocks were grown on the premises of Phil Rucks Citrus Nursery, Frostproof, Fla., using standard citrus nursery practices. Seedlings received both overhead and manual irrigation to maintain adequate soil moisture at all times. Every third day, the overhead irrigation contained 100 ppm NPK plus micronutrients (GraCo Soluble Fertilizer Co., Cairo Georgia). As needed, seedlings received treatments of commercial Imidocloprid insecticide and Ridomil fungicide to control insect pests and soil fungi, respectively.

Rootstock Harvest and Biomass Analysis:

At 76 days after transplanting, ten randomly selected rootstocks were harvested from each treatment group. Rootstocks were cut into root and shoot samples at the soil line. Stem diameters were measured at 4 inches and 8 inches above the soil line using a hand caliper. Shoot height was not determined since some of the rootstocks had been trimmed prior to growth evaluation. For shoot biomass analysis, a 12 inch section of stem was cut from each shoot base. Soil media was removed by hand from the root samples. Each root and stem sample (N=10) was bagged separately and dried overnight at 50° C.

Data Analysis:

Stem diameter and dry weight biomass data were subjected to Analysis of Variance (ANOVA). Separations among treatment means were determined according to Duncan's Multiple Range Test at the 90% level of confidence. Mean values followed by the same level are not statistically significant. Table II below illustrates the results of this analysis:

TABLE II

| | | | Stem | | | |
|---|---|---|---|---|---|---|
| | | | Diameter (mm) | | Root | Shoot |
| | Treatment | | 4 | 8 | Dry | Dry |
| Group | Pot | Soil | inches | inches | Wt (g) | Wt (g) |
| I | Standard | Standard | 5.04 ab | 4.28 a | 3.34 a | 4.20 ab |
| II | Standard | Soil A | 5.33 b | 5.20 b | 4.68 c | 4.87 b |
| III | Air Pruning | Standard | 4.55 a | 4.44 a | 4.12 b | 3.67 a |
| IV | Air Pruning | Soil A | 5.26 b | 4.85 ab | 5.63 d | 4.54 ab |

Results:

Kuharske citrange rootstock shows growth characteristics and long-term tree productivity similar to that of Carrizo citrange. In this study, Kuharske rootstock seedlings showed significantly improved root growth in the Air Pruning Pots (container 30) filled with the soil blend A compared to all other matrix treatments. Additionally, the use of the soil blend A independently of the Air Pruning Pot (Group II), and the use of the Air Pruning Pot independently of the soil blend A (Group III) also produced improved root growth relative to the control (Group I). This shows that the soil blend A or the container 30 alone can provide substantially improved root growth compared to Florida standard methods, and that the soil blend A and the container 30 together can provide even more substantial and synergistic improvement in root growth. The soil blend A is also shown to achieve improved shoot biomass and stem diameter measurements. In both indices of shoot development, the soil blend A showed a stronger influence over shoot development when compared to the air pruning pot design.

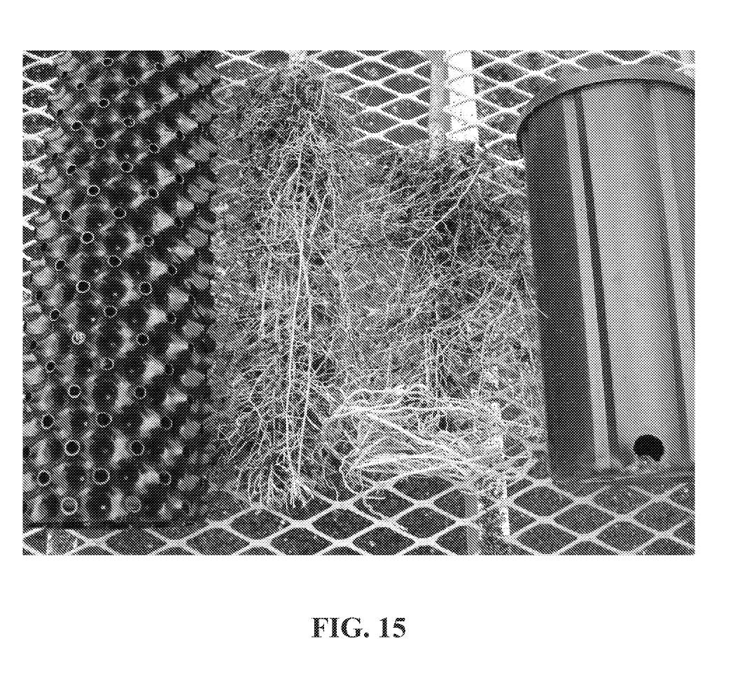

The pot design and architecture was found to have a significant impact on root development in one gallon containers. In this study, the Air Pruning Pots showed improved root placement throughout the soil matrix when compared to the one gallon Standard Pots. Using the soil blend A, roots in the Standard Pots tended to circle the base of the pots that formed an uneven distribution of roots at the bottom of the pot (See FIG. 15, right). The solid bottom construction of the Standard Pot with only small drainage holes appears to aggravate root circling and matting. Matted roots as shown in FIG. 15 are typically cut off when the tree is transplanted to the field, which can result in a loss of up to 40-50% of root mass at the time of field planting. Additionally, transplanted trees with reduced root mass typically are slow to establish and can die due to post-transplant water stress. Root matting was also found to occur in commercial air pruning pots, as described below. In contrast, root development in the 4×14″ Air Pruning Pots such as shown in FIGS. 4-6 was uniformly distributed throughout the soil matrix. Roots were air pruned at the bottom of the pot that effectively prevented root circling at the base of the pot. Additionally, the use of the Air Pruning Pots encouraged growth of more numerous secondary roots, rather than longer, circled roots.

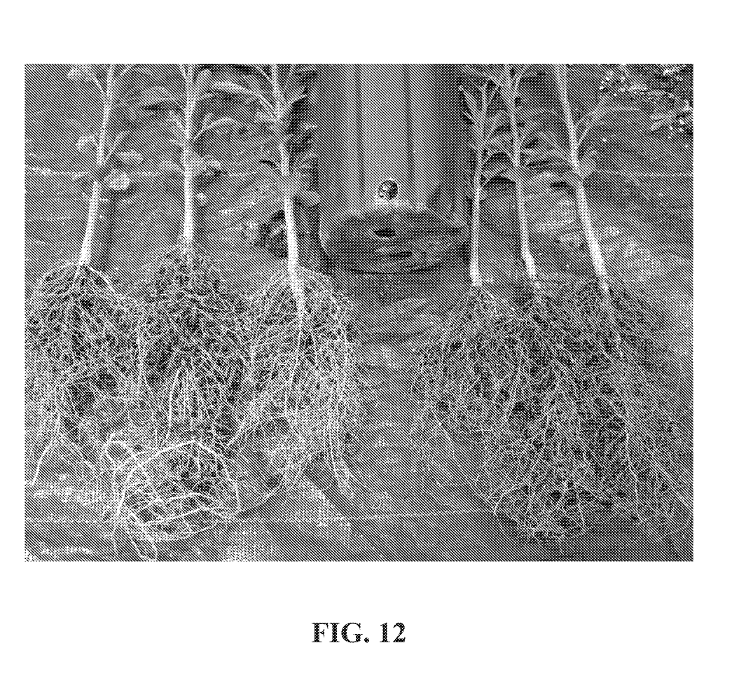

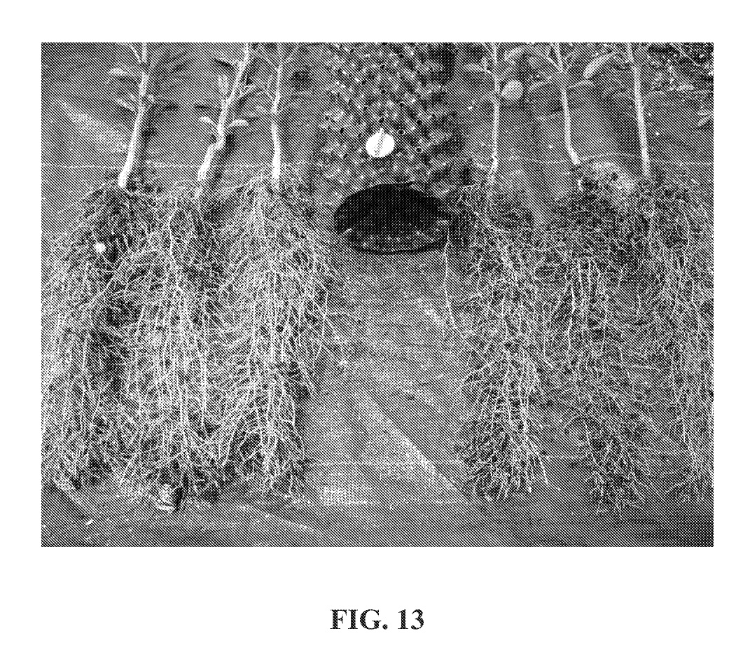

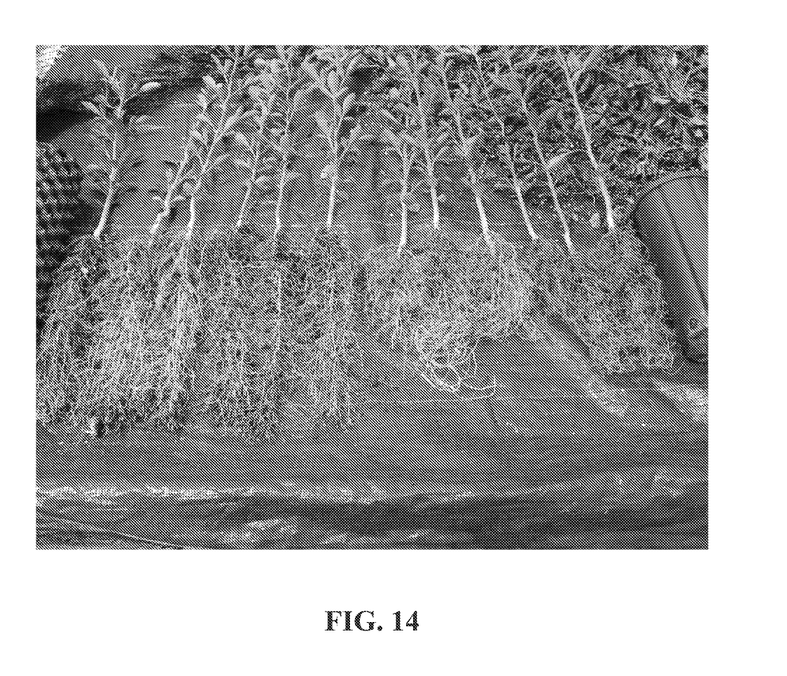

FIGS. 12-15 illustrate plants from the study. FIG. 12 depicts the Group I plants on the right and the Group II plants on the left, with their growing pot in the center. FIG. 13 depicts the Group III plants on the right and the Group IV plants on the left, with their growing pot in the center. FIG. 14 depicts the Group I plants on the far right, the Group II plants on the center right, the Group III plants on the center left, and the Group IV plants on the far left, with the respective growing pots on the right and left. FIG. 15 depicts a Group II plant on the right and a Group IV plant on the left, in addition to their respective growing pots. These figures illustrate the significantly improved root growth, including taproot length, total root biomass, etc., that can be achieved using a container 30 as shown in FIGS. 4-6 and the soil blend A for growth of citrus seedlings.

Based on this study, it is evident that seedlings grown using a container 30 as shown in FIGS. 4-6 and the soil blend A can achieve sufficient root growth to be ready for grafting in as few as 76 days or less (75-80 days in one embodiment). This offers significant advantages over existing containers and soil media, which typically require 90-120 days to be ready for grafting. This significant benefit was unexpected, and can greatly increase efficiency in production of citrus plants, through more rapid growth. It is contemplated that the use of the soil blend B may produce results that are at least comparable to the results achieved by the soil blend B. The use of the container 10 as shown in FIGS. 1-2 along with the soil blend A for germination and growth prior to transplanting to the container 30 may further increase efficiency of production and root growth.

Secondary Study:

A small number of larger containers corresponding to the structure of the container 30 of FIGS. 4-6 were evaluated, having a 6″ diameter and a 14″ height. Kuharske rootstocks showed excellent root development in the 6″ diameter containers when visually compared to root growth in the 4″ diameter pot design. The results (biomass data from 6″ pots not presented) suggest that either pot could be used successfully to improve rootstock liner growth when compared to standard Florida methods. The 6″ pot may pose economic issues, since fewer pots could be placed per square meter in each growing facility, which may in turn reduce economic returns per finished tree.

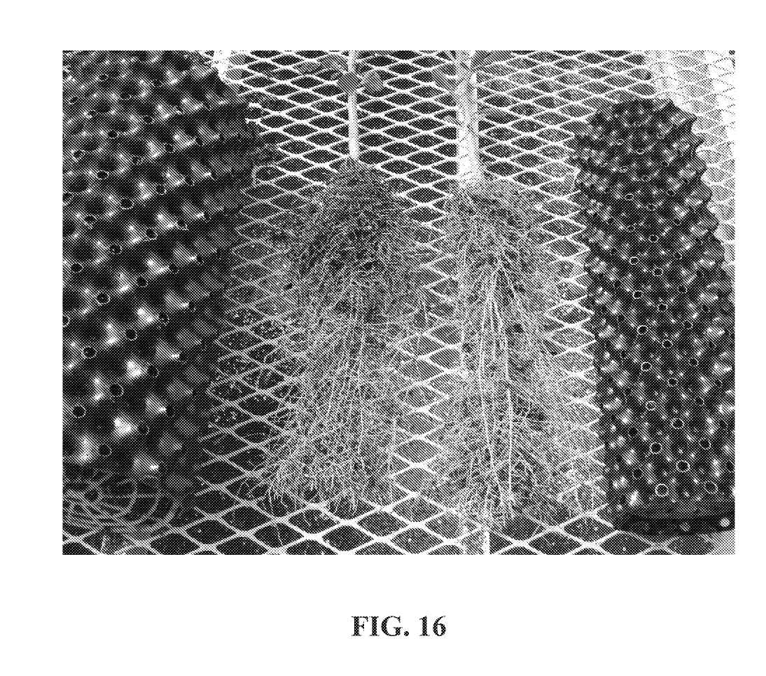

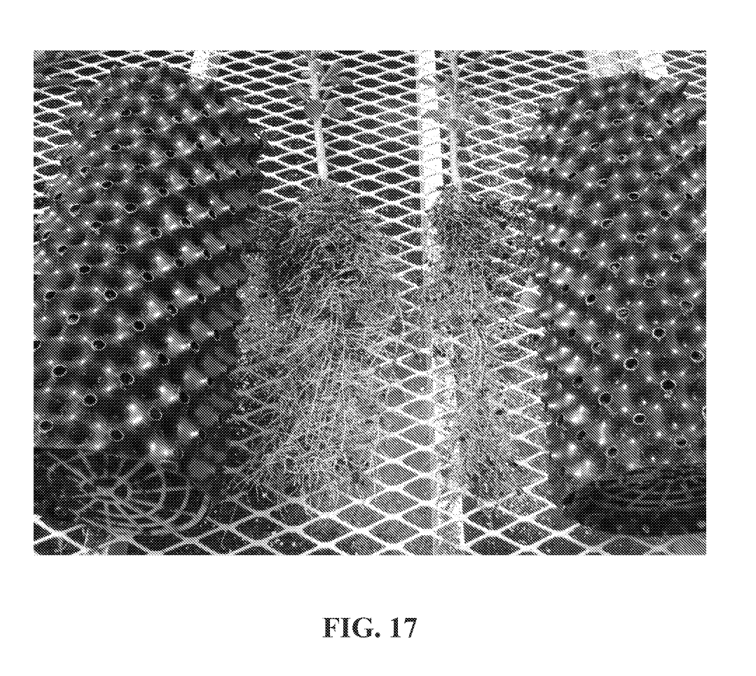

FIGS. 16-17 illustrate plants from the secondary study. FIG. 16 depicts a plant grown in the container 30 of FIGS. 4-6 and having a 6″ diameter and a 14″ height, grown in the soil blend A, along with its growth container, on the left, and a plant from Group IV along with its growth container, on the left. FIG. 17 depicts two plants grown in containers structured as the container 30 of FIGS. 4-6 and having a 6″ diameter and a 14″ height, along with their growth containers, showing a plant grown in the soil blend A on the left and a plant grown in the standard citrus nursery soil mixture on the right. These figures illustrate that the results achieved with the 4″×14″ pot and the 6″×14″ pot are comparable. These figures also illustrate the significantly improved root growth, including taproot length, total root biomass, etc., that can be achieved using the soil blend A for growth of citrus seedlings.

### Example 3

### Full Growth From Germination to Grafting

### Example 3a

### Germination and Early Growth

Plant material and Seed Germination:

Two separate Trials (1 and 2) were conducted using similar or identical growing conditions. Rootstocks seeds of Swingle Citrummelo, Kuharske Citrange, and USDA897 hybrid Citrange were sourced independently from Phil Rucks Citrus Nursery, Frostproof, Fla., (Trial 1) and Rasnake Citrus Nursery, Winter Haven, Fla., (Trial 2) and represent commercial seed inventories of commercial rootstock selections. Seeds were planted in standard rootstock production greenhouses in a variety of seed germination containers and soil mixtures, as described below. Plant growth conditions in greenhouse culture were the same as described in Example 1 above. Rootstock seed germination was approximately 90% across all treatments in both nursery locations and was considered typical for commercial production.

Rootstock Seed Germination Trays and Potting Media:

Seed germination trays utilized include:
Group I: Standard seed germination tray having cells that are 1.25″×5″ with a standard solid wall construction and a single hole base. This tray was the same as was used in Example 1, Group I;
Group II: An assembly 20 with containers 10 described above and shown in FIGS. 1-3.

The trays described above were used in connection with different soil media. Group I used a standard citrus nursery soil mixture containing 78% Canadian peatmoss, 12% composted pinebark, and 10% perlite. Group II used a soil blend corresponding to soil blend A described above:
40% Canadian peatmoss;
30% Coconut coir;
30% Cypress bark sawdust;
5 lb. dolomite limestone per finished yard;
5 lb. gypsum per finished yard;
4 lb. micronutrients per finished yard;
18.5 lb. HuMaxx humic acid per finished yard; and
10 lb. 15-6-12 Polyon 270 day NPK+ per finished yard.

In each treatment group, seedlings were cultured for 80 days (Trial 1) and 96 days (Trial 1) in seed germination pots and soil for later upsizing to larger containers.

Rootstock Seedling Culture:

All rootstocks were grown using standard greenhouse growing conditions and treatments that were substantially the same as described in Example 1 above. Irrigation of all test trees was applied by hand as required to maintain adequate soil moisture at all times.

Seedling Harvest and Biomass Analysis:

Within each seed germination treatment group, Swingle, Kuharske, and USDA897 seedlings were randomly chosen (N=25) for biomass and plant growth analysis 96 days after germination (Trial 1) and 80 days after germination (Trial 2). Seedlings were cut into root and shoot samples at the soil line. Shoot diameters were determined at 5 cm above soil level. Shoot height was also determined for each seedling. Soil media were removed manually from the root samples. For dry weight analysis, root and shoot samples (N=25) were randomly divided into groups of five seedlings, replicated five times. Samples were dried at 50° C. overnight to constant dry weight prior to biomass determinations.

Data Analysis:

All plant biomass and plant growth data were subjected to Analysis of Variance (ANOVA). Statistically significant separations among seedling treatment means were determined according to the Least Significant Difference (LSD) Test at the 95% level of confidence and the Mann-Whitney Test at the >95% level of confidence. Mean separations among mature plant treatments were determined according to the Two Sample T-Test method, at the 90% confidence level. Mean values followed by the same letter are not statistically significant. Table III below illustrates the results of this analysis for Trial 1, and Table IV below illustrates the results of this analysis for Trial 2:

TABLE III

| | | | | |
|---|---|---|---|---|
| | Root Dry | Shoot Dry | | |
| Group ID | Wt (g) | Wt (g) | Stem Ht (cm) | Stem Dia (mm) |

Swingle citrummelo hybrid citrange (mean values, N = 25)

| | | | | |
|---|---|---|---|---|
| Group I | 0.9 a | 1.4 a | 7.3 a | 1.3 a |
| Group II | 1.6 b | 2.9 b | 13.6 b | 2.0 b |

Kuharske citrange (mean values, N = 25)

| | | | | |
|---|---|---|---|---|
| Group I | 1.2 a | 2.2 a | 12.8 a | 1.6 a |
| Group II | 1.9 b | 3.5 b | 17.4 b | 1.9 b |

USDA 897 Hybrid citrange (mean values, N = 25)

| | | | | |
|---|---|---|---|---|
| Group I | 0.7 a | 1.8 a | 12.5 a | 1.2 a |
| Group II | 1.3 b | 3.8 b | 21.1 b | 1.9 b |

TABLE IV

| | | | | |
|---|---|---|---|---|
| | Root Dry | Shoot Dry | | |
| Group ID | Wt (g) | Wt (g) | Stem Ht (cm) | Stem Dia (mm) |

Swingle citrummelo hybrid citrange (mean values, N = 25)

| | | | | |
|---|---|---|---|---|
| Group I | 0.4 a | 1.0 a | 8.9 a | 1.2 a |
| Group II | 1.2 b | 2.6 b | 17.1 b | 2.1 b |

Kuharske citrange (mean values, N = 25)

| | | | | |
|---|---|---|---|---|
| Group I | 0.5 a | 0.7 a | 6.5 a | 1.2 a |
| Group II | 0.7 b | 1.5 b | 13.5 b | 1.7 b |

USDA 897 Hybrid citrange (mean values, N = 25)

| | | | | |
|---|---|---|---|---|
| Group I | 0.3 a | 0.6 a | 6.1 a | 1.0 a |
| Group II | 0.8 b | 2.1 b | 15.1 b | 1.8 b |

Results:

Combination of the soil blend A and air pruning pots having an architecture as described above and shown in FIGS. 1-2 (Group II) significantly increased seedling growth of Swingle, Kuharske, and USDA897 rootstocks. All of the growth indices were significantly increased compared to the growth of the standard control seedlings. Across all rootstocks at both locations, the use of the soil blend A and the air pruning pots generally doubled plant production for Group II when compared to controls. Importantly, stem diameters of Group II were significantly increased compared to Group I, which effectively reduced the time required to grow seedlings large enough to graft to sweet orange scion selections. Shoot weight, stem height, and root growth were also significantly larger in Group II than in Group I.

Based on this study, it is evident that seedlings germinated and grown using a container 10 as shown in FIGS. 1-2 and the soil blend A can achieve improved root growth and plant growth relative to other containers, soil blends, and combinations thereof.

### Example 3b

### Long-Term Growth

Plant Material:

Rootstock seedlings of Swingle, Kuharske, and USDA897 from Trials 1 and 2 from Example 3a above were transplanted to the test pot/soil matrix approximately 96 days after germination (Trial 1) and approximately 80 days after germination (Trial 2).

Pots and Growing Media:

The seedlings were transplanted to different pots and soil media. The pots included:
Group IA (Trial 1): Standard round, 1-gallon commercial pot, 6″ diameter, 10″ height, with a solid wall construction with root training grooves, and single hole drainage base;
Group IB (Trial 2): Standard square, 1-gallon commercial pot, 4″ width, 14″ height, with a solid wall construction with root training grooves, and single hole drainage base;
Group II (Trials 1 and 2): The container 30 described above and shown in FIGS. 4-6, with a 4″ diameter and a 14″ height and a 1.0 gallon volume.

These pots were used to form four treatment groups, with two treatment groups for each trial. Groups IA and IB utilized a standard citrus nursery soil mixture, containing 70% Canadian peatmoss, 20% composted pinebark, and 10% perlite. Group II used a soil blend corresponding to soil blend A described above:
40% Canadian peatmoss;
30% Coconut coir;
30% Cypress bark sawdust;
5 lb. dolomite limestone per finished yard;
5 lb. gypsum per finished yard;
4 lb. micronutrients per finished yard;
18.5 lb. HuMaxx humic acid per finished yard; and
10 lb. 15-6-12 Polyon 270 day NPK+ per finished yard.

Rootstock Seedling Culture:

After transplanting to one gallon containers, the rootstocks were grown using standard citrus nursery practices, similar or identical to those described in Example 2 above.

Rootstock Harvest and Biomass Analysis:

At approximately 244 days after germination (Trial 1) and 258 days after germination (Trial 2), ten randomly selected rootstocks were harvested from each treatment group. Rootstocks were cut into root and shoot samples at the soil line. Stem diameters were measured at the soil line and at scion bud grafting height, i.e. approximately 15 cm above the soil line. Shoot height, shoot diameter, root dry weight, and shoot dry weight were determined independently for each test plant. Plants were prepared for dry weight analyses as described in Example 3a above. Dry weights were recorded independently for each test sample, N=10.

Data Analysis:

All plant biomass and plant growth data were subjected to Analysis of Variance (ANOVA). Statistically significant separations among paired treatment means were determined according to the Two Sample T-Test method, at the 90% confidence level. Paired means followed by the same letter are not significantly different. Table V below illustrates the results of this analysis for Trial 1, and Table VI below illustrates the results of this analysis for Trial 2:

TABLE V

| | | | | |
|---|---|---|---|---|
| | Root Dry | Shoot Dry | Stem Diameter, | Stem Diameter, |
| Group ID | Weight (g) | Weight (g) | soil level (mm) | soil + 15 cm (mm) |

Swingle citrummelo hybrid citrange (mean values, N = 25)

| | | | | |
|---|---|---|---|---|
| Group I | 4.14 a | 7.58 a | 7.60 a | 5.85 a |
| Group II | 5.35 b | 10.59 b | 7.95 a | 6.71 b |

Kuharske citrange (mean values, N = 25)

| | | | | |
|---|---|---|---|---|
| Group IA | 5.04 b | 10.19 b | 7.72 a | 6.43 a |
| Group II | 8.73 c | 12.15 c | 8.03 a | 7.59 b |

USDA 897 Hybrid citrange (mean values, N = 25)

| | | | | |
|---|---|---|---|---|
| Group IA | 3.59 a | 7.79 a | 5.80 a | 4.56 a |
| Group II | 5.47 c | 12.68 c | 6.39 b | 5.59 b |

TABLE VI

| | | | | |
|---|---|---|---|---|
| | Root Dry | Shoot Dry | Stem Diameter, | Stem Diameter, |
| Group ID | Weight (g) | Weight (g) | soil level (mm) | soil + 15 cm (mm) |

Swingle citrummelo hybrid citrange (mean values, N = 25)

| | | | | |
|---|---|---|---|---|
| Group IB | 4.39 a | 11.09 a | 6.02 a | 5.43 a |
| Group II | 5.82 b | 13.22 b | 6.36 a | 5.96 b |

Kuharske citrange (mean values, N = 25)

| | | | | |
|---|---|---|---|---|
| Group IB | 3.70 a | 6.85 a | 5.07 a | 4.54 a |
| Group II | 6.13 b | 8.18 b | 5.44 a | 4.91 a |

USDA 897 Hybrid citrange (mean values, N = 25)

| | | | | |
|---|---|---|---|---|
| Group IB | 3.00 a | 7.96 a | 5.35 a | 4.85 a |
| Group II | 4.60 b | 9.70 b | 6.45 b | 5.97 b |

Results:

Combination of the soil blend A and air pruning pots having architectures as described above and shown in FIGS. 4-6 (Group II) significantly increased the growth of Swingle, Kuharske, and USDA897 rootstocks. Most of the growth indices were significantly increased compared to the growth of the standard control plants (Groups IA and IB) for all types of samples. Importantly, the air pruning vents 37 in the sides of the containers 30 generally resulted in significantly improved root growth in Group II when compared to root growth in Groups IA and IB. Shoot weight and stem diameter were generally also significantly larger in Group II than in Groups IA and IB. Additionally, the improved stem growth described above was observed to improve the efficiency of the budding operation.

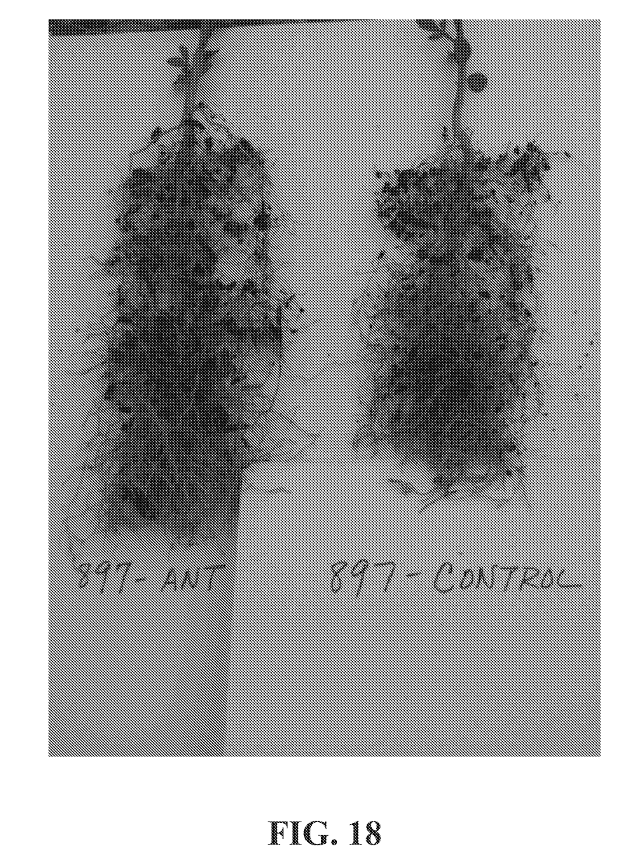

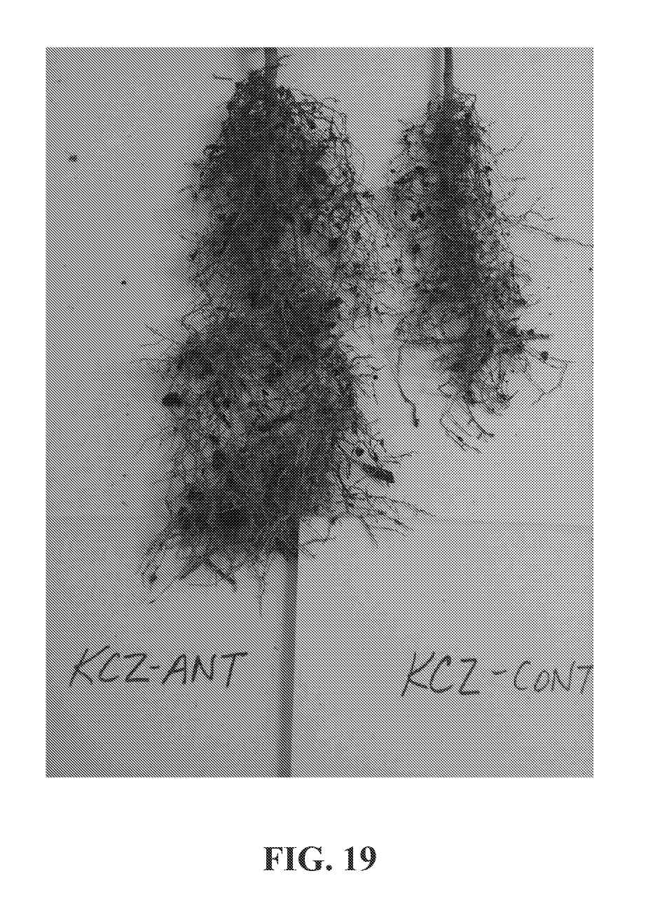

FIGS. 18-19 illustrate plants from the study. FIG. 18 depicts USDA897 plants from Trial 1, with the Group IA on the right and the Group II plants on the left. FIG. 19 depicts Kuharske plants from Trial 1, with the Group IA on the right and the Group II plants on the left. These figures illustrate the significantly improved root growth, including taproot length, total root biomass, etc., as well as stem diameter, that can be achieved using the containers 10, 30 as described above and the soil blend A for growth of citrus seedlings.

Based on Examples 3a and 3b taken together, rootstock growth performance at two commercial nurseries show that the use of air pruning pot architectures as described above (e.g. containers 10, 30), in combination with the soil media as described above (e.g. soil blends A and/or B), can significantly increase rootstock growth and stem development over a period of 8 months after seed germination. These results confirm the initial findings detailed in Examples 1 and 2 above and document the effect of the use of the air pruning pots and soil media described above over the entire rootstock growth period from seed germination to time of tree grafting. These results also indicate that the use of the air pruning pots and soil media described above can reduce the time required to produce finished rootstocks that would improve efficiencies and economic viability of greenhouse nursery operations.

Further Notes:

The three test rootstocks were hybridized using a wide range of citrus germplasm that includes Grapefruit (Citrus paradisi), Sweet Orange (Citrus sinensis), Poncirus trifoliata, and Mandarin (Citrus reticulata). These four species represent a broad range of citrus germplasm. This indicates that the containers and soil blends discussed above would be applicable to the nursery production of all commercial rootstocks used to propagate grafted citrus trees.

### Example 4

### Other Commercial Air Pruning Pots

Commercial citrus tree production was found to be significantly impacted by the height/width architecture of the air pruning containers 30 as shown in FIGS. 4-6, as compared to commercial air pruning pots. Air pruning pots of roughly equal height/width dimensions are generally standard manufacture for nursery tree propagation. Air pruning pots with open bottoms, having a height of 6 to 8 inches and a width of 6 to 12 inches were observed to be unsuitable for propagation of grafted citrus trees. Pots of these dimensions were found to produce citrus rootstocks with short taproots that commercial nurseries would consider to be a production defect. In order to improve pot architecture, the air pruning container 30 as shown in FIGS. 4-6 and used in Examples 2 and 3b were manufactured to have a 14-inch height and a 4-inch width (round). The air pruning containers having these dimensions were found to promote elongated taproot growth with accelerated secondary root development throughout the soil matrix (see, e.g., FIG. 15.). These features of root mass development are critical to promote rapid and vigorous growth of trees after transplanting to the field.

Root matting can also present a problem in commercial air pruning pots, such as one-gallon pots from LaceBark Inc., (e.g., U.S. Pat. No. 4,753,037) that have a smaller height (6 inches×6.5 inches square) than the containers 30 in FIGS. 4-6 and/or a solid bottom construction. The height/width architecture of these air pruning pots evaluated were found to produce a finished tree with a short tap-root and greatly matted bottom roots that would be considered unacceptable for field planting. In contrast, root development in the 4″×14″ air pruning pots such as shown in FIGS. 4-6 was uniformly distributed throughout the soil matrix.

### Examples of Application to Other Plants

As described above, aspects of the present invention, including the containers 10, 30, 40, soil blends, and/or methods described above, can be applied to the germination and/or growth of other plants. Some examples of such plants include, without limitation, apple trees, coconut palm trees, cashew trees, mango trees, and berry plants, such as blackberry, raspberry, and blueberry, as well as others. The use of the containers 10, 30, 40, soil blends, and/or methods described above may achieve a reduction of the number of days to produce a finished seedling apple, coconut, or cashew tree ready to transplant to field location(s). It is understood that certain aspects may be modified or adapted for use with each of these types of plants. These examples are described in greater detail below.

Apple Tree

Commercial apple production, including production of Red and Golden Delicious, is typically derived from clonal rootstocks grafted to high vigor scion selections. Use of dwarfing rootstocks combined with high density planting (e.g. 750-1,000 trees per acre) and trellis culture have revolutionized the production of apple. Examples of rootstocks that are often used successfully in the apple industry include several Malling or Malling-Merton hybrid rootstocks, such as Malling M.9, Malling M.26, Malling MM.106, and Malling G.16 (G.5-A). Such rootstocks show good compatibility with a wide range of scion selections. Budding of apple rootstocks can be executed using any one of the following grafting methods: 1) whip-and-tongue graft, 2) whip grafting, 3) “T” budding, and 4) Chip budding. Grafting is usually done during the dormant season and must be done on dormant scion and rootstock plant materials. In common with citrus nursery methods, advanced apple nurseries often use “T” budding to produce high vigor finished trees. T-budding can be performed in both the Summer months (June budding) and Winter months (dormant budding). The two budding seasons can effectively accelerate propagation of desirable apple cultivars. After the inserted bud has sprouted, budded rootstocks can be potted into one gallon containers that contain a well-drained soil mixture. In order to accelerate field planting and first fruit yields, many commercially budded trees are planted directly to the final field location without container culture in the nursery. Containerized production of grafted apple commonly uses one and two gallon containers without side vents. Pots are typically filled with simple mixtures of sand, peat, and perlite. Most commercial apple nurseries market bare rooted grafted trees that are bagged in moist peatmoss.

Air pruning pots, such as the containers 10, 30, 40 described above, can be used to accelerate root production in apple rootstocks, including dwarfing rootstocks specifically suited for high density culture. Custom blended soil blends, such as described above, can also be used to enhance root development. Seedling apple root development is characterized by development of a moderate taproot with aggressive growth of secondary roots to form a fibrous root ball. In one embodiment, containers as described above that are at least one gallon capacity can be used to support rapid secondary root development of finished apple trees. A pot architecture about 6-8 inches in diameter and 12 inches in height may support root development over a period of 12-16 months. Soil blends as described above, including peat, coconut coir, and perlite blended with a slow release fertilizer containing micronutrients can also be utilized. Addition of humic acid to the soil blend could be beneficial in protecting secondary root tips from fungus and bacterial infection. Adjustment of soil pH to pH 6.0 could be beneficial in facilitating uptake of micronutrients by growing roots. It is understood that additives and components of such blends may be adjusted as necessary.

The methods described above, utilizing the containers 10, 30, 40 and/or soil blends described above, may also be adapted for use in apple tree germination and/or growth. Open hydroponic and in-line fertigation systems may be used in connection with such growing methods, which can result in trees that have stronger secondary root systems for rapid NPK and micronutrient uptake. Trellis culture methods and pest-management programs can also be used. Trees can be transplanted to different containers or the field at different stages, as described above. For example, trees may be grown in containers for one season and then moved to a field site in one embodiment. It is understood that various aspects of the method, soil, and/or containers may be adjusted for apple production.

Coconut Palm

Coconut palm trees are generally grown in tropical areas. Coconut palm is propagated entirely by seed. Nuts from fully mature trees are harvested when they still contain liquid endosperm (coconut water). Nuts are placed on their sides and buried to one half the depth of the nut. Nuts can be germinated in prepared seed beds or in containers, and can be germinated in containers as described above. Germination may be accomplished, in one example, at temperatures of about 90-100° F. Upon germination, the shoot and root emerge through the side or one end of the nut. Young palms, about 6 months old, can be transplanted directly into the field or into larger containers to be grown for one to two years before transplanting. Coconut varieties may be selected for their tolerance to the Lethal Yellow virus disease. For example, the Malayan dwarf coconut is tolerant to the Lethal Yellow disease. The Fiji Dwarf coconut (or Niu Leka) is also tolerant to the Lethal Yellow disease, and is a slow growing variety that produces a large percentage of off-type seedlings in nursery production.

Coconut palm can be successfully grown along sandy shorelines or inland in frost-free zones. Coconut palm tolerates a wide range of soil types and soil pH values, from pH 5.0-8.0, providing the soils are well drained. Successful culture is best performed at a minimum average temperature of 72° F. and annual rainfall of 30-50 inches or more. Coconut palm is tolerant of temporary flooding and should be grown in full sunlight. Coconut palm is also tolerant of saline water, as well as salt spray in coastline plantings. New plantings begin to bear fruit at 6 years after planting of seed-grown nursery stock.

Containers 10, 30, 40 as described above can be used for coconut palm production, including germination and/or growth. It is thought that coconut root growth may be dependent on hormone levels throughout root initiation and cell growth. Containers 10, 30, 40 with air pruning holes, as described above, may significantly improve root hormone production in secondary root tips. For example, in one embodiment, a container 10, 30, 40 as described above may be utilized for coconut growth, having a diameter or 12-18 inches or a 12-18 inch square periphery, with a height of 10-14 inches and a volume of 3-5 gallons. Soil blends as described above, which may be coconut coir-based soil blends, may also be used for coconut production. Seedling coconut palms are highly susceptible to potassium, magnesium, manganese, and boron deficiencies. Accordingly, slow release fertilizer with micronutrients may be included in the soil blend to address any micronutrient deficiencies in the soil, and to accelerate total root growth and secondary root formation. Addition of organic matter (e.g. manure) to the soil blend may not be required, but may be used in one embodiment. The soils should be well drained, and pest-management programs may be used. BioChar (a carbon additive) and soil pH adjustments (e.g. limestone, gypsum) may also be beneficial. In one embodiment, BioChar may be added at a rate of 2-5 lbs/cubic yard of container soil mix. It is understood that additives and components of such blends may be adjusted as necessary.

The methods described above, utilizing the containers 10, 30, 40 and/or soil blends described above, may also be adapted for use in coconut palm germination and/or growth. Container-grown seedlings may advantageously be planted at the same depth as grown in the nursery. Supplemental irrigation/fertigation may also be used. Trees are typically planted at spacing of 18 to 30 feet apart. High density plantings should avoid tree to tree shading in row. Plants may be moved from containers to field planting in approximately 6 months after transplanting from the seed germination bed. It is understood that various aspects of the method, soil, and/or containers may be adjusted for coconut production.

Cashew Tree

Cashew trees are relatively drought-tolerant, but flourish in tropical growing environments, and generally requires a frost-free climate. Cashew trees are well adapted to many well-drained soil types that include both light sands and limestone soils, but grow best in well-drained sandy soils with a pH of 4.5 to 6.5. Cashew is typically propagated by seed. Fresh seeds can be planted in well-drained soil at a depth of 5-10 cm and typically germinate in 1-2 weeks after sowing. Seedlings can be transplanted when 20-50 cm tall, typically at 4-8 weeks after seed germination. Cashew can also be propagated by grafting, inarching, or air-layering. Grafting methods similar to those used to propagate citrus can also be used to propagate cashew trees. Seedlings are typically grown in containerized culture. Careful selection of scion budwood may improve tree propagation, and clones of proven fruit yield and vigor would be selected as scion budwood. Grafted trees typically bear fruits in 2-3 years whereas seed-grown nursery stock bear fruits in 5-6 years after seed planting. The juvenility period for seed-grown cashew is similar to that of seed-grown citrus. Cashew seedling growth is characterized by strong taproot development. Taproot development continues after trees are planted to field locations and long term productivity is determined by balanced taproot and lateral root formation. Cashew can be grown in high density plantations but care must be given to not over-plant trees, which can result in root competition between trees and loss of productivity.

Containers 10, 30, 40 as described above can be used for cashew tree production, including germination and/or growth. The containers 10, 30, 40 used may be of the same or similar sizes to those described above for use in germination and/or growth of citrus plants. Soil blends as described above, which may be coconut coir-based soil blends, may also be used for coconut production. The containers 10, 30, 40 and/or the soil blends may promote taproot and secondary root formation in cashew trees in container culture. This can, in turn, achieve a reduction of the number of days to produce a finished seedling tree ready to transplant to field location(s). Adjustment of soil pH to around 6.0 to 6.5 can be advantageous in promoting rapid and healthy root growth of germinating seeds. For growing seedlings, adjustment of soil pH to around 5.0 to 6.0 can be advantageous. Cashew trees, particularly if grown in alkaline limestone soils, may develop micronutrient deficiencies, including iron, zinc, and manganese. Incorporation of organic matter and/or BioChar in the soil blend may also be useful. Soil drainage and pest management programs may be used as well.

The methods described above, utilizing the containers 10, 30, 40 and/or soil blends described above, may also be adapted for use in cashew tree germination and/or growth. Cashew production in the nursery may follow many of the same methods as for citrus rootstock production. Plants may be ready for grafting in one season or less, and may be moved from containers to field planting in two years or less. Mature trees may require pruning to maintain sunlight penetration between trees to develop strong full canopies. It is understood that various aspects of the method, soil, and/or containers may be adjusted for cashew production.

Berry Plants

Berry plants, such as blackberry, raspberry, and blueberry, show a wide range of freeze hardiness that allows specific cultivars to be grown in a wide variety of climates. As an example, the following blackberry cultivars are commonly grown in the United States:

| | Cultivar | |
|---|---|---|
| Most cold | Kiowa | Wisconsin, Michigan, Illinois, Arkansas, |
| hardy | | Missouri |
| | Arapaho | Illinois, Nebraska, Ohio, Kentucky, Arkansas |
| | Shawnee | Illinois, Ohio, Kentucky, Tennessee, Virginia |
| | Navaho | Virginia, Maryland, Delaware, |
| | | North Carolina |
| | Chickasaw | N-S Carolina, Delaware, Maryland, Arkansas |
| Least cold | Apache | Georgia, North Florida, Mississippi, |
| hardy | | Alabama |

Berries are generally propagated by vegetative cuttings that include: 1) leafy stem cuttings, 2) root cuttings, 3) suckering, and 4) tip layering. Conventional methods to graft scion to rootstock are generally not used. For each growing region, it is important to choose cultivars that are well suited for the local growing environment. For both home garden and commercial plantings, rooted berry plants are purchased from nurseries in the winter months while the plants are dormant. Dormant plants can be held under chilled conditions until they can be planted in early Spring. Cultivar choice may be influenced by the particular growing environment of the test site(s). These selections would be vegetatively propagated during the Summer months for planting the following Spring.

Berries typically show fibrous root growth habits. Root systems of young plants are very delicate and easily damaged and/or killed by over fertilization. Many berry nurseries use only organic composts in their propagation soil mixes to avoid fertilizer damage to newly propagated plants. Most berries are propagated in shallow flats filled with a loamy soil, rich in organic matter. Rooted cuttings are transferred to individual pots for growing to finished plants ready to transplant to field or home garden locations. Improvement of nursery propagation of berry cuttings could be accomplished through the use of air pruning pots, such as the containers 10, 30, 40 described above, to increase secondary root growth to produce strong plants. In one embodiment, a container for growth of berry plants may be a shallow pot with a diameter of 8-12 inches and a height of 4-6 inches, due to their fibrous root systems. Such a container may be a typical container or a container 10, 30, 40 as described above with such dimensions. Multiple cuttings could be planted in one pot to create a community flat of cuttings. After rooting, individual plants can be transplanted to air pruning containers, such as the containers 10, 30, 40 described above. In one embodiment, a container 10, 30, 40 as described above could be used for individual plants, with a diameter of 4-5 inches and a height of 4-6 inches. The use of such a container 10, 30, 40 may achieve a reduction of the number of days to produce finished plants ready to transplant to field location(s). Rooted cuttings could be grown for 6-8 months prior to movement to field locations.

Soil blends as described above can be used for berry propagation, and may significantly improve rooting and plant development. Soil blends that contain coconut coir, peatmoss, and cypress dust may be used in one embodiment, which can support rapid penetration of the soil mix by the delicate fibrous roots of berry plants. Coconut coir and peatmoss can also assist in retaining adequate moisture to support root growth but also provide good drainage in the soil mix. In one embodiment, humic acid may be used to retard microbial growth and dolomite lime may be used to adjust soil pH to about 5.5-6.5. Berry cuttings may benefit from a slow release fertilizer to support root development without burning of delicate root systems. Addition of micronutrients may be used in one embodiment to further support rapid root growth throughout the soil mix. The same or a similar soil blend could be used both for long term culture of rooted berry cuttings and for the rooting process. Additional slow release fertilizer could be applied as a top-dressing, if necessary. Further, management of rooted berry cuttings could include treatments of soil applied fungicides (e.g. Ridomil) to retard infestation of Phytopthora soil fungus. Foliage applied fungicides could be used to control Anthracnose leaf spot in the nursery.

The methods described above, utilizing the containers 10, 30, 40 and/or soil blends described above, may also be adapted for use in berry plant growth. Container-grown plants can be transplanted to the field when ready. Plant spacing in the field is cultivar dependent. In general, erect cultivars may be spaced from 2 to 4 feet in-row. Trailing cultivars may be spaced from 3-5 feet in-row. Rows are spaced from 10 to 15 feet between rows, depending on plant vigor and farm machinery limitations. Organic matter (manure or compost), BioChar charcoal, and low nitrogen NPK+ micronutrients may be incorporated in one embodiment, as berries typically require loamy soils rich in organic matter. Soils should be well drained with a pH value of 5.5 to 6.5. In highly alkaline soils, acidification of soil may be accomplished using gypsum and/or soil sulfur. Drip irrigation may also be used in place of overhead irrigation, which can encourage leaf spot fungus infection that reduces fruit yield and plant vigor.

Improvement of commercial plantings may be achieved through balanced NPK fertilizer treatments to support strong cane development and maximum fruit yields. Over-application of nitrogen (urea) early in the growing season can force weak cane/bush growth that reduces fruit yield. Ground applied fertilizers may be applied 12-18 inches from the base of the plants to avoid burning of the shallow and delicate root systems of most berries. Balanced application of manganese, zinc, iron, and boron can support strong cane/bush growth. Leaf tissue analysis of NPK and micronutrients may be performed, in order to maintain all nutrients in proper balance. Potassium levels in leaf tissues should be monitored in the Fall season. If necessary, in-line fertigation of potassium can be applied to maximize cold hardiness of the berry plants during the winter months. Trailing berry cultivars can be grown using trellis culture with supplemental irrigation/fertigation. Selective pruning of trellis-grown canes can be used to promote flower bud initiation. Selective pruning of berry bushes also improves air circulation between canes/limbs that may reduce infections by fungi that cause leaf spot and twig die-back. It is understood that various aspects of the method, soil, and/or the containers described above may be adjusted for berry production.

Mango Trees

The mango is a member of the same plant family as the cashew and pistachio. Mangos are typically grown in tropical and subtropical areas of the world that do not experience freezing temperatures. Mangos do not acclimate to cold temperatures and all cultivars show similar cold sensitivity. Young trees can be killed at 29 F to 30 F. India produces approximately 65% of the world's commercial mango crop, and Florida, Puerto Rico, and Hawaii have small but locally important commercial mango industries.

Mango trees can be propagated by seed and grafting. Recent selections of Indochinese mango rootstocks have greatly improved mango tree propagation for home and commercial plantings. Indochinese mango cultivars are particularly well-suited as rootstock germplasm since these selections produce polyembryonic seeds. Rootstock seedlings grown from polyembryonic seeds are genetically identical. Several new dwarfing rootstocks have improved commercial fruit production in young trees (ages 3-5 years after planting) using high density planting designs. Indochinese cultivars may be used in one embodiment for seed germination and rootstock propagation. In Florida, the following polyembryonic mango selections may be advantageous when utilized as rootstocks:

| | |
|---|---|
| Florigon | moderately resistant to Anthracnose leaf spot fungus |
| Saigon | resistant to Anthracnose leaf spot fungus |
| Nam Doc Mai | moderately susceptible to Anthracnose leaf spot fungus |
| Turpentine | resistant to Anthracnose leaf spot fungus, |
| | tolerant of high pH soils |

Improvement of mango fruit production in Florida may be achieved using cultivars that have shown excellent field performance when grown in South Florida. Several potentially advantageous cultivars for the Florida growing environment include:

| | |
|---|---|
| Tommy Atkins | red/yellow fruit color, standard by which all cultivars |
| | are judged |
| Keitt | pink/yellow fruit color, large fruit size, excellent fruit |
| | quality |
| Kent | red/yellow fruit color, large fruit size, excellent |
| | productivity |
| Haden | red/yellow fruit color, excellent fruit size and quality |

Grafting is a reliable and economical method to propagate mango. A method known as “veneer” grafting is typically performed to produce grafted finished trees. Nursery managers usually produce grafted mango in container culture using a simple growth medium of Canadian peat/composted bark/perlite. Mango is characterized as a taproot-forming tree. The use of containers that are at least 8-10 inches tall can support taproot development during seedling growth. Grafting should be done in the warmest months of the year with night temperatures above 18° C. (64° F.).

The use of air pruning pots, such as the containers 10, 30, 40 as described above, can achieve improved growth and accelerate secondary root growth of mango rootstock seedlings. In one embodiment, a container 10, 30, 40 as described above may be used with a diameter of 6-8 inches and a height of 12-14 inches, which can accommodate aggressive taproot development of rootstock seedlings. In another embodiment, after grafting, a container 10, 30, 40 as described above may be used with a diameter of 8-12 inches and a height of at least 14 inches. The use of such containers 10, 30, 40 may achieve a reduction of the number of days to produce finished trees ready to transplant to field location(s).

Soil blends as described above can be used for mango propagation, and may significantly improve rooting and plant development. In one embodiment, a soil blend may contain coconut coir, peatmoss, perlite, and cypress dust, along with a slow release NPK fertilizer with micronutrients. Adequate levels of manganese, zinc, and iron micronutrients contribute to promoting healthy root cell division and cell growth. Humic acid may also be added to the soil blend to retard microbial growth in the medium. The pH of the soil blend may advantageously be adjusted to about 6.0-7.0, such as by using dolomite lime.

The methods described above, utilizing the containers 10, 30, 40 and/or soil blends described above, may also be adapted for use in mango rootstock seed germination and/or grafted tree growth. Seedlings would be grown for a period of 3-5 months prior to grafting. The trees would then be grafted using the veneer grafting method. After the grafted trees have resumed vegetative growth, seedlings can be transferred to larger pots to facilitate continued growth of the central taproot. The soil blend for long term growth may be same as for seed germination, with the addition of 20% cypress bark to retard breakdown on the growing medium. A top-dressing of slow release fertilizer with micronutrients can be used with grafted trees to accelerate tree growth. Periodic treatments of commercial fungicide can be used for nursery trees to suppress Anthracnose leaf spot fungus contamination while the trees are in the nursery.

High density spacing can be used for commercial mango plantings to maximize fruit production in young trees (e.g. 4-6 years after planting). Grafted nursery stock can be utilized in order to avoid juvenility problems in seed propagated mango. Seed propagated mango trees typically will not bear fruits until 6-8 years after planting whereas grafted trees will begin to bear fruits 3-5 years after planting. Mangos are well adapted to many soil types. Although mango trees are moderately tolerant of occasional flooding or excessively wet soil conditions, they may not perform well in poorly drained soils. Accordingly, soils should be well-drained, and installation of subterranean tile drainage may be used in poorly-drained soils. Typical mango plantations are planted in a 30 ft×30 ft grid planting. Dwarfing rootstocks can accommodate high density 15 ft in-row×25 ft between-row planting designs. Supplemental irrigation using either drip or microjet technologies may be advantageously used. In highly calcareous soils, addition of BioChar charcoal, gypsum, and NPK+ micronutrients may be beneficial. Long-term mango tree production may incorporate selective pruning of upper limbs to manage tree canopy size and shape, thereby reducing tree maintenance costs and greatly reducing risk of tree injury from storms and/or hurricanes. It is understood that various aspects of the method, soil, and/or the containers described above may be adjusted for mango production.

While specific embodiments and examples have been described and illustrated herein, it is understood that further embodiments and variations may exist within the scope and spirit of the invention, and that the scope of the invention is limited only by the claims. Also, while the terms “top,” “bottom,” “side,” and the like may be used in this specification to describe various example features and elements of the invention, these terms are used herein as a matter of convenience, e.g., based on the example orientations shown in the figures or the orientation during typical use. Additionally, the term “plurality,” as used herein, indicates any number greater than one, either disjunctively or conjunctively, as necessary, up to an infinite number.

What is claimed is:

1. A container comprising:
a sidewall defining an internal cavity having an outermost peripheral dimension, a top having an opening providing access to the cavity and a bottom, with a depth defined between the top and the bottom, the cavity configured to hold a soil medium and a plant growing in the soil medium, wherein the outermost peripheral dimension of the sidewall has a width of about 1.0 to 1.25 inches and the depth is about 5.0 to 7.0 inches; and
a plurality of air pruning holes defined within the sidewall and extending through the sidewall, the air pruning holes being dispersed across the sidewall.

2. The container of claim 1, wherein the sidewall is at least partially conical and a width of the cavity decreased from the top toward the bottom, and the container is configuring for holding a seed for germination to create the plant.

3. The container of claim 1, wherein the sidewall has a width-to-depth ratio of approximately 0.18, based on the width of the outermost peripheral dimension.

4. The container of claim 1, wherein the bottom of the sidewall is open, and a number of the air pruning holes are located around the bottom.

5. The container of claim 1, wherein at least some of the air pruning holes are circular.

6. An assembly comprising a tray and a plurality of containers according to claim 1 connected to and supported by the tray, each of the containers holding a soil medium and a plant growing in the soil medium at least partially within the cavity.

7. An assembly comprising the container according to claim 1, a soil medium at least partially filling the cavity, and a plant growing in the soil medium, wherein the soil medium comprises about 40% peatmoss, about 30% Coconut coir, and about 30% Cyprus bark sawdust and one or more of the following additives, with each additive having a range of +/−10% of listed amounts:
5 lb. dolomite limestone per finished yard;
5 lb. gypsum per finished yard;
4 lb. micronutrients per finished yard;
18.5 lb. humic acid per finished yard; and
10 lb. slow-release NPK supplement per finished yard.

8. A container comprising:
a sidewall defining an internal cavity having an outermost peripheral dimension, a top having an opening providing access to the cavity and a bottom, with a depth defined between the top and the bottom, the cavity configured to hold a soil medium and a plant growing in the soil medium, wherein the outermost peripheral dimension of the sidewall has a width of about 4.0 to 6.0 inches and the depth is about 12.0 inches to 14.0 inches; and
a plurality of air pruning holes defined within the sidewall and extending through the sidewall, the air pruning holes being dispersed across the sidewall.

9. The container of claim 8, wherein the sidewall further comprises a plurality of tubular structures extending outwardly from the sidewall, each tubular structure defining one of the air pruning holes therethrough.

10. The container of claim 9, wherein the sidewall further comprises a plurality of inwardly-extending projections extending into the cavity, the projections being located between the tubular structures.

11. The container of claim 10, wherein the sidewall has a width-to-depth ratio of approximately 0.43, based on the width of the outermost peripheral dimension.

12. The container of claim 8, wherein the sidewall is cylindrical in shape and the bottom of the sidewall is open.

13. The container of claim 8, wherein the depth of the sidewall is 14.0 inches.

14. The container of claim 13, wherein the width of the sidewall is 6.0 inches.

15. The container of claim 8, wherein the sidewall has a width-to-depth ratio of approximately 0.43, based on the width of the outermost peripheral dimension.

16. An assembly comprising the container according to claim 8, a soil medium at least partially filling the cavity, and a plant growing in the soil medium, wherein the soil medium comprises about 40% peatmoss, about 30% Coconut coir, and about 30% Cyprus bark sawdust and one or more of the following additives, with each additive having a range of +/−10% of listed amounts:
5 lb. dolomite limestone per finished yard;
5 lb. gypsum per finished yard;
4 lb. micronutrients per finished yard;
18.5 lb. humic acid per finished yard; and
10 lb. slow-release NPK supplement per finished yard.

17. An assembly comprising the container according to claim 8, a soil medium at least partially filling the cavity, and a plant growing in the soil medium, wherein the soil medium comprises about 30% peatmoss, about 20% Coconut coir, about 20% Cyprus bark chips, and about 20% Cyprus bark sawdust, and about 10% perlite and one or more of the following additives, with each additive having a range of +/−10% of listed amounts:
5 lb. dolomite limestone per finished yard;
5 lb. gypsum per finished yard;
5 lb. coarse grade limestone per finished yard;
4 lb. micronutrients per finished yard;
18.5 lb. humic acid per finished yard; and
20 lb. slow-release NPK supplement per finished yard.

18. A soil medium comprising about 40% peatmoss, about 30% Coconut coir, and about 30% Cyprus bark sawdust and one or more of the following additives, with each additive having a range of +/−10% of listed amounts:
5 lb. dolomite limestone per finished yard;
5 lb. gypsum per finished yard;
4 lb. micronutrients per finished yard;
18.5 lb. humic acid per finished yard; and
10 lb. slow-release NPK supplement per finished yard.

19. A soil medium comprising about 30% peatmoss, about 20% Coconut coir, about 20% Cyprus bark chips, and about 20% Cyprus bark sawdust, and about 10% perlite and one or more of the following additives, with each additive having a range of +/−10% of listed amounts:
5 lb. dolomite limestone per finished yard;
5 lb. gypsum per finished yard;
5 lb. coarse grade limestone per finished yard;
4 lb. micronutrients per finished yard;
18.5 lb. humic acid per finished yard; and
20 lb. slow-release NPK supplement per finished yard.

20. A method comprising:
providing a container comprising a sidewall defining an internal cavity having an outermost peripheral dimension, a top having an opening providing access to the cavity and a bottom, with a depth defined between the top and the bottom, wherein the outermost peripheral dimension of the sidewall has a width of about 1.0 to 1.25 inches and the depth is about 5.0 to 7.0 inches, wherein the a plurality of air pruning holes are defined within the sidewall and extend through the sidewall, the air pruning holes being dispersed across the sidewall;
placing a soil medium within the cavity of the container; and
placing a seed within the soil medium, wherein the seed germinates to produce a plant growing in the soil medium.

21. The method of claim 20, wherein the soil medium comprises about 40% peatmoss, about 30% Coconut coir, and about 30% Cyprus bark sawdust and one or more of the following additives, with each additive having a range of +/−10% of listed amounts:
5 lb. dolomite limestone per finished yard;
5 lb. gypsum per finished yard;
4 lb. micronutrients per finished yard;
18.5 lb. humic acid per finished yard; and
10 lb. slow-release NPK supplement per finished yard.

22. A method comprising:
providing a container comprising a sidewall defining an internal cavity having an outermost peripheral dimension, a top having an opening providing access to the cavity and a bottom, with a depth defined between the top and the bottom, wherein the outermost peripheral dimension of the sidewall has a width of about 4.0 to 6.0 inches and the depth is about 12.0 inches to 14.0 inches, wherein the a plurality of air pruning holes are defined within the sidewall and extend through the sidewall, the air pruning holes being dispersed across the sidewall;
placing a soil medium within the cavity of the container; and
transplanting a plant to the container, such that a root of the plant is at least partially within the soil medium, and the plant is supported by the soil medium.

23. The method of claim 22, wherein the soil medium comprises about 40% peatmoss, about 30% Coconut coir, and about 30% Cyprus bark sawdust and one or more of the following additives, with each additive having a range of +/−10% of listed amounts:
5 lb. dolomite limestone per finished yard;
5 lb. gypsum per finished yard;
4 lb. micronutrients per finished yard;
18.5 lb. humic acid per finished yard; and
10 lb. slow-release NPK supplement per finished yard.

24. The method of claim 22, wherein the soil medium comprises about 30% peatmoss, about 20% Coconut coir, about 20% Cyprus bark chips, and about 20% Cyprus bark sawdust, and about 10% perlite and one or more of the following additives, with each additive having a range of +/−10% of listed amounts:
5 lb. dolomite limestone per finished yard;
5 lb. gypsum per finished yard;
5 lb. coarse grade limestone per finished yard;
4 lb. micronutrients per finished yard;
18.5 lb. humic acid per finished yard; and
20 lb. slow-release NPK supplement per finished yard.
